(19) United States
(12) Patent Application Publication
(10) Pub. No.: US 2025/0294590 A1
(43) Pub. Date: Sep. 18, 2025

(54) RESOURCE RESERVATION TECHNIQUES FOR SIDELINK COMMUNICATIONS

(71) Applicant: QUALCOMM INCORPORATED, San Diego, CA (US)

(72) Inventors: Siyi Chen, Beijing (CN); Jing Sun, San Diego, CA (US); Chih-Hao Liu, San Diego, CA (US); Xiaoxia Zhang, San Diego, CA (US); Changlong Xu, Beijing (CN); Shaozhen Guo, Beijing (CN); Luanxia Yang, Beijing (CN); Hao Xu, Beijing (CN)

(21) Appl. No.: 18/861,323

(22) PCT Filed: Jun. 17, 2022
(86) PCT No.: PCT/CN2022/099399

§ 371 Date: Oct. 29, 2024

(51) Int. Cl. H04W 72/25; H04L 27/26; H04W 74/0808

(52) U.S. Cl. CPC H04W 72/25; H04L 27/2678; H04W 74/0808

(57) ABSTRACT

Methods, systems, and devices for wireless communications are described. A user equipment (UE) may transmit sidelink control information (SCI) that indicates a set of resources reserved for sidelink communications at the UE. Each of the reserved resources may include a respective slot and a respective sub-channel of a shared radio frequency channel. The UE may perform a listen-before-talk (LBT) procedure associated with a sub-channel of a reserved resource prior to accessing the reserved resource. In some examples, the UE may perform a mini-slot transmission if the LBT procedure is unsuccessful. In other examples, the UE may use a cyclic prefix extension (CPE) to access the sub-channel before a start of the reserved resource. In some examples, the reserved resource may span two or more consecutive slots with the same sub-channel index. The described techniques may enable the UE to perform sidelink communications with greater reliability and higher throughput.

### CROSS REFERENCE

The present Application is a 371 national stage filing of International PCT Application No. PCT/CN2022/099399 by Chen et al. entitled “RESOURCE RESERVATION TECHNIQUES FOR SIDELINK COMMUNICATIONS,” filed Jun. 17, 2022, which is assigned to the assignee hereof, and which is expressly incorporated by reference in its entirety herein.

### FIELD OF TECHNOLOGY

The following relates to wireless communications, including resource reservation techniques for sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a communication device may perform a listen-before-talk (LBT) procedure prior to transmitting a message via resources in a shared radio frequency spectrum band. In addition, resources may be reserved in advance using control information shared between devices. However, if LBT procedures for reserved resources are unsuccessful, transmission of the message may be delayed or cancelled.

### SUMMARY

The described techniques relate to improved methods, systems, devices, and apparatuses that support resource reservation techniques for sidelink communications. For example, the described techniques provide for improving the efficiency and reliability of sidelink communications in a shared radio frequency spectrum band. In accordance with aspects of the present disclosure, a user equipment (UE) may transmit sidelink control information (SCI) that indicates a set of resources reserved for sidelink communications at the UE. Each of the reserved resources may include a respective slot and a respective sub-channel of a shared radio frequency channel. The UE may perform a listen-before-talk procedure associated with a sub-channel of a reserved resource prior to accessing the reserved resource. In some examples, the UE may perform a mini-slot transmission if the listen-before-talk procedure is unsuccessful. In other examples, the UE may use a cyclic prefix extension (CPE) to access the sub-channel before a start of the reserved resource. In some examples, the reserved resource may span two or more consecutive slots with the same sub-channel index. The described techniques may enable the UE to perform sidelink communications with greater reliability and higher throughput.

A method for wireless communications at a UE is described. The method may include transmitting SCI that indicates a set of reserved resources for sidelink communications at the UE, each of the set of reserved resources including a respective slot of multiple slots and a respective sub-channel of a shared radio frequency channel that includes multiple sub-channels. The method may further include determining that a sub-channel of a reserved resource is occupied at a beginning of a slot of the reserved resource based on performing a first listen-before-talk (LBT) procedure prior to the slot. The method may further include transmitting, via the sub-channel of the reserved resource, a sidelink message during a mini-slot of the reserved resource based on performing a second LBT procedure prior to the mini-slot, where the mini-slot begins after the beginning of the slot.

An apparatus for wireless communications at a UE is described. The apparatus may include a processor, memory coupled with the processor, and instructions stored in the memory. The instructions may be executable by the processor to cause the apparatus to transmit SCI that indicates a set of reserved resources for sidelink communications at the UE, each of the set of reserved resources including a respective slot of multiple slots and a respective sub-channel of a shared radio frequency channel that includes multiple sub-channels. The instructions may be further executable by the processor to cause the apparatus to determine that a sub-channel of a reserved resource is occupied at a beginning of a slot of the reserved resource based on performing a first LBT procedure prior to the slot. The instructions may be further executable by the processor to cause the apparatus to transmit, via the sub-channel of the reserved resource, a sidelink message during a mini-slot of the reserved resource based on performing a second LBT procedure prior to the mini-slot, where the mini-slot begins after the beginning of the slot.

Another apparatus for wireless communications at a UE is described. The apparatus may include means for transmitting SCI that indicates a set of reserved resources for sidelink communications at the UE, each of the set of reserved resources including a respective slot of multiple slots and a respective sub-channel of a shared radio frequency channel that includes multiple sub-channels. The apparatus may further include means for determining that a sub-channel of a reserved resource is occupied at a beginning of a slot of the reserved resource based on performing a first LBT procedure prior to the slot. The apparatus may further include means for transmitting, via the sub-channel of the reserved resource, a sidelink message during a mini-slot of the reserved resource based on performing a second LBT procedure prior to the mini-slot, where the mini-slot begins after the beginning of the slot.

A non-transitory computer-readable medium storing code for wireless communications at a UE is described. The code may include instructions executable by a processor to transmit SCI that indicates a set of reserved resources for sidelink communications at the UE, each of the set of reserved resources including a respective slot of multiple slots and a respective sub-channel of a shared radio frequency channel that includes multiple sub-channels. The instructions may be further executable by the processor to determine that a sub-channel of a reserved resource is occupied at a beginning of a slot of the reserved resource based on performing a first LBT procedure prior to the slot. The instructions may be further executable by the processor to transmit, via the sub-channel of the reserved resource, a sidelink message during a mini-slot of the reserved resource based on performing a second LBT procedure prior to the mini-slot, where the mini-slot begins after the beginning of the slot.

In some examples of the method, apparatuses, and non-transitory computer-readable medium described herein, the reserved resource is a first reserved resource that is prior to a second reserved resource of the set of reserved resources.

Some examples of the method, apparatuses, and non-transitory computer-readable medium described herein may further include operations, features, means, or instructions for transmitting the sidelink message during the mini-slot of the reserved resource based on the reserved resource being a last reserved resource of the set of reserved resources.

In some examples of the method, apparatuses, and non-transitory computer-readable medium described herein, the SCI indicates one or more of the set of reserved resources that are available for mini-slot transmissions.

Some examples of the method, apparatuses, and non-transitory computer-readable medium described herein may further include operations, features, means, or instructions for receiving an indication of a sidelink resource pool with a mini-slot structure and selecting the set of reserved resources from the sidelink resource pool based on a resource selection mode of the UE.

In some examples of the method, apparatuses, and non-transitory computer-readable medium described herein, the set of reserved resources includes a second reserved resource that occurs prior to the reserved resource and the method, apparatuses, and non-transitory computer-readable medium may include further operations, features, means, or instructions for performing a third LBT procedure prior to a second slot associated with the second reserved resource, where the third LBT procedure completes an offset prior to the second slot.

In some examples of the method, apparatuses, and non-transitory computer-readable medium described herein, the SCI indicates respective channel access modifications for each of the set of reserved resources and the respective channel access modifications for the reserved resource includes a mini-slot channel access.

A method for wireless communications at a UE is described. The method may include transmitting SCI that indicates a set of reserved resources for sidelink communications at the UE, each of the set of reserved resources including a respective slot of multiple slots and a respective sub-channel of a shared radio frequency channel that includes multiple sub-channels. The method may further include performing a LBT procedure associated with a sub-channel of a reserved resource prior to a slot of the reserved resource. The method may further include transmitting a sidelink message with a CPE via the sub-channel of the reserved resource based on a result of the LBT procedure, where transmission of the CPE begins prior to the slot of the reserved resource.

An apparatus for wireless communications at a UE is described. The apparatus may include a processor, memory coupled with the processor, and instructions stored in the memory. The instructions may be executable by the processor to cause the apparatus to transmit SCI that indicates a set of reserved resources for sidelink communications at the UE, each of the set of reserved resources including a respective slot of multiple slots and a respective sub-channel of a shared radio frequency channel that includes multiple sub-channels. The instructions may be further executable by the processor to cause the apparatus to perform a LBT procedure associated with a sub-channel of a reserved resource prior to a slot of the reserved resource. The instructions may be further executable by the processor to cause the apparatus to transmit a sidelink message with a CPE via the sub-channel of the reserved resource based on a result of the LBT procedure, where transmission of the CPE begins prior to the slot of the reserved resource.

Another apparatus for wireless communications at a UE is described. The apparatus may include means for transmitting SCI that indicates a set of reserved resources for sidelink communications at the UE, each of the set of reserved resources including a respective slot of multiple slots and a respective sub-channel of a shared radio frequency channel that includes multiple sub-channels. The apparatus may further include means for performing a LBT procedure associated with a sub-channel of a reserved resource prior to a slot of the reserved resource. The apparatus may further include means for transmitting a sidelink message with a CPE via the sub-channel of the reserved resource based on a result of the LBT procedure, where transmission of the CPE begins prior to the slot of the reserved resource.

A non-transitory computer-readable medium storing code for wireless communications at a UE is described. The code may include instructions executable by a processor to transmit SCI that indicates a set of reserved resources for sidelink communications at the UE, each of the set of reserved resources including a respective slot of multiple slots and a respective sub-channel of a shared radio frequency channel that includes multiple sub-channels. The instructions may be further executable by the processor to perform a LBT procedure associated with a sub-channel of a reserved resource prior to a slot of the reserved resource. The instructions may be further executable by the processor to transmit a sidelink message with a CPE via the sub-channel of the reserved resource based on a result of the LBT procedure, where transmission of the CPE begins prior to the slot of the reserved resource.

In some examples of the method, apparatuses, and non-transitory computer-readable medium described herein, the reserved resource is a first reserved resource that is prior to a second reserved resource of the set of reserved resources.

Some examples of the method, apparatuses, and non-transitory computer-readable medium described herein may further include operations, features, means, or instructions for transmitting the sidelink message with the CPE based on the reserved resource being a last reserved resource of the set of reserved resources.

In some examples of the method, apparatuses, and non-transitory computer-readable medium described herein, the SCI indicates one or more of the set of reserved resources that are available for sidelink transmissions with CPEs.

In some examples of the method, apparatuses, and non-transitory computer-readable medium described herein, the SCI indicates an offset for a candidate slot from the slot for retransmission of the sidelink message.

Some examples of the method, apparatuses, and non-transitory computer-readable medium described herein may further include operations, features, means, or instructions for receiving radio resource control (RRC) signaling that indicates one or more possible durations of the CPE.

In some examples of the method, apparatuses, and non-transitory computer-readable medium described herein, a duration of the CPE is based on a priority level of the sidelink message.

In some examples of the method, apparatuses, and non-transitory computer-readable medium described herein, transmitting the sidelink message with the CPE may include operations, features, means, or instructions for determining that use of the sub-channel by devices associated with a second radio access technology (RAT) fails to satisfy a threshold.

A method for wireless communications at a UE is described. The method may include transmitting first SCI that indicates a set of reserved resources for sidelink communications at the UE, each of the set of reserved resources including a respective slot of multiple slots and a respective sub-channel of a shared radio frequency channel that includes multiple sub-channels. The method may further include determining that a sub-channel of a reserved resource is occupied during a first slot of the reserved resource based on performing a first LBT procedure prior to the first slot. The method may further include transmitting a sidelink message in a second slot based on performing a second LBT procedure prior to the second slot, where the second slot is based on the first slot.

An apparatus for wireless communications at a UE is described. The apparatus may include a processor, memory coupled with the processor, and instructions stored in the memory. The instructions may be executable by the processor to cause the apparatus to transmit first SCI that indicates a set of reserved resources for sidelink communications at the UE, each of the set of reserved resources including a respective slot of multiple slots and a respective sub-channel of a shared radio frequency channel that includes multiple sub-channels. The instructions may be further executable by the processor to cause the apparatus to determine that a sub-channel of a reserved resource is occupied during a first slot of the reserved resource based on performing a first LBT procedure prior to the first slot. The instructions may be further executable by the processor to cause the apparatus to transmit a sidelink message in a second slot based on performing a second LBT procedure prior to the second slot, where the second slot is based on the first slot.

Another apparatus for wireless communications at a UE is described. The apparatus may include means for transmitting first SCI that indicates a set of reserved resources for sidelink communications at the UE, each of the set of reserved resources including a respective slot of multiple slots and a respective sub-channel of a shared radio frequency channel that includes multiple sub-channels. The apparatus may further include means for determining that a sub-channel of a reserved resource is occupied during a first slot of the reserved resource based on performing a first LBT procedure prior to the first slot. The apparatus may further include means for transmitting a sidelink message in a second slot based on performing a second LBT procedure prior to the second slot, where the second slot is based on the first slot.

A non-transitory computer-readable medium storing code for wireless communications at a UE is described. The code may include instructions executable by a processor to transmit first SCI that indicates a set of reserved resources for sidelink communications at the UE, each of the set of reserved resources including a respective slot of multiple slots and a respective sub-channel of a shared radio frequency channel that includes multiple sub-channels. The instructions may be further executable by the processor to determine that a sub-channel of a reserved resource is occupied during a first slot of the reserved resource based on performing a first LBT procedure prior to the first slot. The instructions may be further executable by the processor to transmit a sidelink message in a second slot based on performing a second LBT procedure prior to the second slot, where the second slot is based on the first slot.

In some examples of the method, apparatuses, and non-transitory computer-readable medium described herein, each of the set of reserved resources includes a respective multiple consecutive slots and a respective sub-channel of a shared radio frequency channel that includes multiple sub-channels and the respective multiple consecutive slots for the reserved resource includes the first slot and the second slot.

Some examples of the method, apparatuses, and non-transitory computer-readable medium described herein may further include operations, features, means, or instructions for suppressing performing additional LBT procedures to access the sub-channel for remaining slots of the respective multiple consecutive slots of the reserved resource subsequent to the second slot.

Some examples of the method, apparatuses, and non-transitory computer-readable medium described herein may further include operations, features, means, or instructions for receiving RRC signaling that indicates a quantity of the respective multiple consecutive slots the UE can reserve for each of the set of reserved resources and selecting the set of reserved resources for transmission of the sidelink message based on the RRC signaling.

In some examples of the method, apparatuses, and non-transitory computer-readable medium described herein, the first SCI indicates a quantity of the respective multiple consecutive slots in each of the set of reserved resources.

Some examples of the method, apparatuses, and non-transitory computer-readable medium described herein may further include operations, features, means, or instructions for receiving second SCI that indicates a second set of reserved resources for sidelink communications by a second UE, each of the second set of reserved resources including a respective multiple consecutive slots and a respective sub-channel of the shared radio frequency channel, receiving third SCI from the second UE in a first slot of the respective multiple consecutive slots of a second reserved resource of the second set of reserved resources, and performing a LBT procedure for access to a corresponding sub-channel of the second reserved resource prior to a second slot of the respective multiple consecutive slots of the second reserved resource based on receiving the third SCI.

In some examples of the method, apparatuses, and non-transitory computer-readable medium described herein, transmitting the sidelink message may include operations, features, means, or instructions for transmitting the sidelink message with a CPE via the sub-channel of the reserved resource based on a result of the second LBT procedure, where transmission of the CPE begins prior to the second slot of the reserved resource.

In some examples of the method, apparatuses, and non-transitory computer-readable medium described herein, the sidelink message includes a retransmission of a first message, where the first SCI and the first message are transmitted in a third slot that precedes the first slot.

In some examples of the method, apparatuses, and non-transitory computer-readable medium described herein, the sidelink message includes second SCI and the method, apparatuses, and non-transitory computer-readable medium may include further operations, features, means, or instructions for multiplexing the second SCI with a sidelink synchronization signal block (S-SSB) in the second slot.

In some examples of the method, apparatuses, and non-transitory computer-readable medium described herein, the second SCI indicates a second set of reserved resources for sidelink communications by the UE and the first LBT procedure is a first type of LBT procedure and the second LBT procedure is a second type of LBT procedure.

In some examples of the method, apparatuses, and non-transitory computer-readable medium described herein, transmitting the second SCI may include operations, features, means, or instructions for transmitting the S-SSB via resources of a sidelink resource pool.

In some examples of the method, apparatuses, and non-transitory computer-readable medium described herein, transmitting the second SCI may include operations, features, means, or instructions for transmitting the second SCI multiplexed with the S-SSB based on a time gap between a last slot of the set of reserved resources and the second slot.

In some examples of the method, apparatuses, and non-transitory computer-readable medium described herein, a duration of the time gap is configured via RRC signaling.

In some examples of the method, apparatuses, and non-transitory computer-readable medium described herein, the second SCI is frequency division multiplexed (FDM) with the S-SSB.

A method for wireless communications at a UE is described. The method may include receiving SCI that indicates a first set of reserved resources for sidelink communications at a second UE, each resource in the first set of reserved resources including a respective slot of multiple slots and a respective sub-channel of a shared radio frequency channel that includes multiple sub-channels. The method may further include transmitting an indication of the first set of reserved resources to a network entity based on a resource selection mode of the UE. The method may further include receiving control signaling that indicates a second set of reserved resources for sidelink communications by the UE, where the first set of reserved resources for the second UE is different from the second set of reserved resources for the UE.

An apparatus for wireless communications at a UE is described. The apparatus may include a processor, memory coupled with the processor, and instructions stored in the memory. The instructions may be executable by the processor to cause the apparatus to receive SCI that indicates a first set of reserved resources for sidelink communications at a second UE, each resource in the first set of reserved resources including a respective slot of multiple slots and a respective sub-channel of a shared radio frequency channel that includes multiple sub-channels. The instructions may be further executable by the processor to cause the apparatus to transmit an indication of the first set of reserved resources to a network entity based on a resource selection mode of the UE. The instructions may be further executable by the processor to cause the apparatus to receive control signaling that indicates a second set of reserved resources for sidelink communications by the UE, where the first set of reserved resources for the second UE is different from the second set of reserved resources for the UE.

Another apparatus for wireless communications at a UE is described. The apparatus may include means for receiving SCI that indicates a first set of reserved resources for sidelink communications at a second UE, each resource in the first set of reserved resources including a respective slot of multiple slots and a respective sub-channel of a shared radio frequency channel that includes multiple sub-channels. The apparatus may further include means for transmitting an indication of the first set of reserved resources to a network entity based on a resource selection mode of the UE. The apparatus may further include means for receiving control signaling that indicates a second set of reserved resources for sidelink communications by the UE, where the first set of reserved resources for the second UE is different from the second set of reserved resources for the UE.

A non-transitory computer-readable medium storing code for wireless communications at a UE is described. The code may include instructions executable by a processor to receive SCI that indicates a first set of reserved resources for sidelink communications at a second UE, each resource in the first set of reserved resources including a respective slot of multiple slots and a respective sub-channel of a shared radio frequency channel that includes multiple sub-channels. The instructions may be further executable by the processor to transmit an indication of the first set of reserved resources to a network entity based on a resource selection mode of the UE. The instructions may be further executable by the processor to receive control signaling that indicates a second set of reserved resources for sidelink communications by the UE, where the first set of reserved resources for the second UE is different from the second set of reserved resources for the UE.

Some examples of the method, apparatuses, and non-transitory computer-readable medium described herein may further include operations, features, means, or instructions for receiving a message that indicates a duration of a LBT procedure, a contention window size of the second UE, or both and signaling one or both of the contention window size of the second UE or the duration of the LBT procedure to the network entity based on the resource selection mode of the UE.

A method for wireless communications at a network entity is described. The method may include receiving an indication of a first set of reserved resources for sidelink communications by a first UE, each resource in the first set of reserved resources including a respective slot of multiple slots and a respective sub-channel of a shared radio frequency channel that includes multiple sub-channels. The method may further include transmitting control signaling to a second UE that indicates a second set of reserved resources for sidelink communications by the second UE, where the first set of reserved resources for the second UE is different from the second set of reserved resources for the UE.

An apparatus for wireless communications at a network entity is described. The apparatus may include a processor, memory coupled with the processor, and instructions stored in the memory. The instructions may be executable by the processor to cause the apparatus to receive an indication of a first set of reserved resources for sidelink communications by a first UE, each resource in the first set of reserved resources including a respective slot of multiple slots and a respective sub-channel of a shared radio frequency channel that includes multiple sub-channels. The instructions may be further executable by the processor to cause the apparatus to transmit control signaling to a second UE that indicates a second set of reserved resources for sidelink communications by the second UE, where the first set of reserved resources for the second UE is different from the second set of reserved resources for the UE.

Another apparatus for wireless communications at a network entity is described. The apparatus may include means for receiving an indication of a first set of reserved resources for sidelink communications by a first UE, each resource in the first set of reserved resources including a respective slot of multiple slots and a respective sub-channel of a shared radio frequency channel that includes multiple sub-channels. The apparatus may further include means for transmitting control signaling to a second UE that indicates a second set of reserved resources for sidelink communications by the second UE, where the first set of reserved resources for the second UE is different from the second set of reserved resources for the UE.

A non-transitory computer-readable medium storing code for wireless communications at a network entity is described. The code may include instructions executable by a processor to receive an indication of a first set of reserved resources for sidelink communications by a first UE, each resource in the first set of reserved resources including a respective slot of multiple slots and a respective sub-channel of a shared radio frequency channel that includes multiple sub-channels. The instructions may be further executable by the processor to transmit control signaling to a second UE that indicates a second set of reserved resources for sidelink communications by the second UE, where the first set of reserved resources for the second UE is different from the second set of reserved resources for the UE.

In some examples of the method, apparatuses, and non-transitory computer-readable medium described herein, the second set of reserved resources does not overlap with a time gap reserved for a LBT procedure prior to each of the first set of reserved resources.

In some examples of the method, apparatuses, and non-transitory computer-readable medium described herein, the time gap is based on a maximum contention window size associated with a priority level of the first UE, a minimum contention window size associated with the priority level of the first UE, a mean contention window size associated with the priority level of the first UE, or a combination thereof.

### BRIEF DESCRIPTION OF THE DRAWINGS

FIGS. 1 and 2 illustrate examples of wireless communications systems that support resource reservation techniques for sidelink communications in accordance with one or more aspects of the present disclosure.

FIGS. 3A and 3B illustrate examples of resource diagrams that support

resource reservation techniques for sidelink communications in accordance with one or more aspects of the present disclosure.

FIG. 4 illustrates an example of a resource diagram that supports resource reservation techniques for sidelink communications in accordance with one or more aspects of the present disclosure.

FIGS. 5A and 5B illustrate examples of resource diagrams that support resource reservation techniques for sidelink communications in accordance with one or more aspects of the present disclosure.

FIGS. 6A and 6B illustrate examples of resource diagrams that support resource reservation techniques for sidelink communications in accordance with one or more aspects of the present disclosure.

FIGS. 7 and 8 show block diagrams of devices that support resource reservation techniques for sidelink communications in accordance with one or more aspects of the present disclosure.

FIG. 9 shows a block diagram of a communications manager that supports resource reservation techniques for sidelink communications in accordance with one or more aspects of the present disclosure.

FIG. 10 shows a diagram of a system including a device that supports resource reservation techniques for sidelink communications in accordance with one or more aspects of the present disclosure.

FIGS. 11 and 12 show block diagrams of devices that support resource reservation techniques for sidelink communications in accordance with one or more aspects of the present disclosure.

FIG. 13 shows a block diagram of a communications manager that supports resource reservation techniques for sidelink communications in accordance with one or more aspects of the present disclosure.

FIG. 14 shows a diagram of a system including a device that supports resource reservation techniques for sidelink communications in accordance with one or more aspects of the present disclosure.

FIGS. 15 through 19 show flowcharts illustrating methods that support resource reservation techniques for sidelink communications in accordance with one or more aspects of the present disclosure.

### DETAILED DESCRIPTION

A shared radio frequency spectrum band may be accessible to different radio access technologies (RATs). A shared radio frequency spectrum band may refer to an unlicensed radio frequency spectrum band, a radio frequency spectrum band that is licensed to more than one operator (e.g., shared between devices associated with more than one operator), or a radio frequency spectrum band that is licensed to one operator with opportunistic access for other devices. A shared radio frequency spectrum band may also be called a shared radio frequency channel. For example, a sidelink unlicensed (SL-U) band may be accessible to Wi-Fi devices and New Radio (NR) devices. Some NR devices may use a resource reservation system to reduce the likelihood of signal collisions occurring between NR devices operating in the shared radio frequency spectrum band. An NR user equipment (UE) can reserve resources for sidelink communications in the shared radio frequency spectrum band by transmitting sidelink control information (SCI) to other devices operating in the shared radio frequency spectrum band. Using the SCI to reserve resources in the shared radio frequency spectrum band may reduce the likelihood of signals from the NR UE colliding with signals from other NR devices.

However, the NR UE may still experience signal collisions and interference from devices associated with other RATs. That is, Wi-Fi devices may be unable to determine whether resources in the shared radio frequency spectrum band have been reserved by NR devices. As such, some Wi-Fi devices may use resources that were previously reserved by the NR UE. Access to the shared radio frequency spectrum band, including for reserved resources between NR devices, may still be subject to success of a listen-before-talk (LBT) procedure. For example, the NR UE may perform an LBT procedure before transmitting the SCI to the other devices in the shared radio frequency spectrum band. However, if the NR UE is unable to transmit the SCI (due to an unsuccessful LBT procedure), the NR UE may be unable to reserve subsequent resources in the shared radio frequency spectrum band.

Aspects of the present disclosure support improved resource reservation techniques for NR devices operating in a shared radio frequency spectrum band. More specifically, the techniques described herein provide for using mini-slot transmissions, cyclic prefix extensions (CPEs), and resource reservation bursts to improve the efficiency of NR resource reservation schemes. As an example, if an NR UE performs an LBT procedure and detects that a sub-channel in the shared radio frequency spectrum band is occupied at the beginning of a slot, the NR UE may perform another LBT procedure at a different point in the slot. If this LBT procedure is successful, the NR UE may use the remainder of the slot for a mini-slot transmission (a transmission that spans fewer than 14 symbols).

Additionally or alternatively, the NR UE may use a CPE to increase the likelihood of accessing resources in the shared radio frequency spectrum band when the NR UE is unable to reserve other resources (due to an LBT failure). Accessing the resources early may deter other devices (e.g., Wi-Fi devices, devices associated with other RATs) from using the resources. In some examples, the NR UE may use SCI to reserve a burst of consecutive resources (slots) associated with the same sub-channel index. The NR UE may also reserve resources in the shared radio frequency spectrum band by multiplexing SCI with a sidelink synchronization signal block (S-SSB) in accordance with a Category 2 LBT procedure. In other examples, a network entity may use information provided by the NR UE to make scheduling decisions (e.g., reserve resources) for other NR devices operating in the shared radio frequency spectrum band.

Aspects of the present disclosure may be implemented to realize one or more of the following advantages. The described techniques may enable an NR UE operating in a shared radio frequency spectrum band to transmit sidelink messages with fewer signal collisions, greater reliability, and higher throughput, among other benefits. For example, an NR UE may transmit a CPE via a wireless medium (e.g., a sub-channel of a shared radio frequency spectrum channel) prior to the start of a time slot in which the NR UE intends to transmit a sidelink message, which may reduce the probability of other devices (e.g., Wi-Fi devices) using the wireless medium during the time slot. Moreover, if the NR UE determines that the wireless medium is occupied at the start of the time slot, the NR UE may still perform a mini-slot transmission within the time slot if the wireless medium becomes available during the time slot. As a result, the NR UE may perform sidelink communications with higher throughput and reduced latency.

Aspects of the disclosure are initially described in the context of wireless communications systems and resource diagrams. Aspects of the disclosure are further illustrated by and described with reference to apparatus diagrams, system diagrams, and flowcharts that relate to resource reservation techniques for sidelink communications.

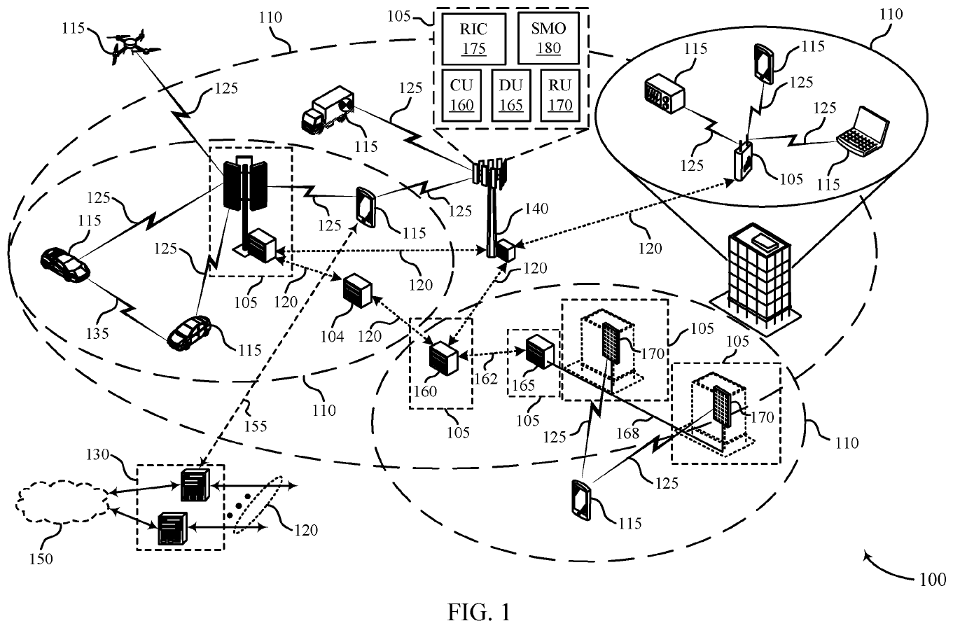

FIG. 1 illustrates an example of a wireless communications system 100 that supports resource reservation techniques for sidelink communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support resource reservation techniques for sidelink communications, as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples. Different categories of carrier sensing may be defined for access to a shared radio frequency spectrum band. For example, Category 1 (CAT 1) LBT may correspond to no LBT, Category 2 (CAT 2) LBT may correspond to LBT without random back-off, Category 3 (CAT 3) LBT may correspond to LBT with random back-off with fixed size of contention window, and Category 4 (CAT 4) LBT may correspond to LBT with random back-off with variable size of contention window.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless communications systems may support different resource selection modes for UEs 115. In Mode 1, resource selection may be controlled (signaled) by a network entity 105. In Mode 2, resource selection may be controlled by a UE 115. Resource selection in Mode 2 includes identification of candidate resources by sensing and exclusion and candidate resource selection from the identified resources. This is performed by higher layers using random selection. Resource allocation is reservation-based in NR sidelink systems. Resource allocation may be performed using units of sub-channels (in the frequency domain) and slots (in the time domain). A transmission reserves resources in the current slot and up to two subsequent slots. Reservation information is conveyed (signaled) via SCI. Reservations can be made in a window of 32 logical slots. The wireless communications system 100 may support periodic and aperiodic resource reservations. For aperiodic reservations, configurable values between 0 ms and 1000 ms can be signaled via SCI. Periodic resource reservations and signaling can be preconfigured or disabled or enabled via an updated configuration.

The slots and resource blocks reserved for a physical sidelink shared channel (PSSCH) transmission may depend on the resources used for a corresponding physical sidelink control channel (PSCCH) transmission that includes an associated SCI format 1-A and one or more fields (Frequency resource assignment, Time resource assignment) of the associated SCI format 1-A. A first field (Time resource assignment) may indicate a logical slot offset of N=1 or 2 actual resources when a first parameter (sl-MaxNumPerReserve) has a value of 2, and may indicate a logical slot offset of N=1, 2, or 3 actual resources when the first parameter (sl_MaxNumPerReserve) has a value of 3. The logical slot offset may be signaled as a time resource indicator value. A starting sub-channel (n_{subDH,0}^{start}) of the first reserved resource may be determined according to one or more rules. The number of contiguously allocated sub-channels for each of the N resources and the starting sub-channel indexes of resources indicated by the associated SCI format 1-A (except for the slot in which SCI format 1-A was received) may be determined from a second field (Frequency resource assignment), which may be signalled as a frequency resource indicator value.

In accordance with aspects of the present disclosure, a UE 115 may transmit SCI that indicates a set of resources reserved for sidelink communications at the UE 115. Each of the reserved resources may include a respective slot and a respective sub-channel of a shared radio frequency channel. The UE 115 may perform an LBT procedure associated with a sub-channel of a reserved resource prior to accessing the reserved resource. In some examples, the UE 115 may perform a mini-slot transmission if the LBT procedure is unsuccessful. In other examples, the UE 115 may use a CPE to access the sub-channel before a start of the reserved resource. In some examples, the reserved resource may span two or more consecutive slots with the same sub-channel index. Additionally or alternatively, if the UE 115 experiences an LBT failure prior to a last reserved slot, the UE 115 may transmit a CAT 2 LBT-based SCI (which may be multiplexed with an S-SSB). If the UE 115 supports Mode 1 resource selection (controlled by the network), the UE 115 may forward reservation information for other UEs 115 to a network entity 105.

Aspects of the wireless communications system 100 may be implemented to realize one or more of the following advantages. The techniques described with reference to FIG. 1 may enable a UE 115 operating in a shared radio frequency spectrum band to transmit sidelink messages with fewer signal collisions, greater reliability, and higher throughput, among other benefits. For example, a UE 115 may transmit a CPE via a wireless medium (e.g., a sub-channel of a shared radio frequency spectrum channel) prior to the start of a time slot in which the UE 115 intends to transmit a sidelink message, which may reduce the probability of other devices (e.g., Wi-Fi devices) using the wireless medium during the time slot. Moreover, if the UE 115 determines that the wireless medium is occupied at the start of the time slot, the UE 115 may still perform a mini-slot transmission within the time slot if the wireless medium becomes available prior to a mini-slot boundary. As a result, the UE 115 may perform sidelink communications with higher throughput and reduced latency.

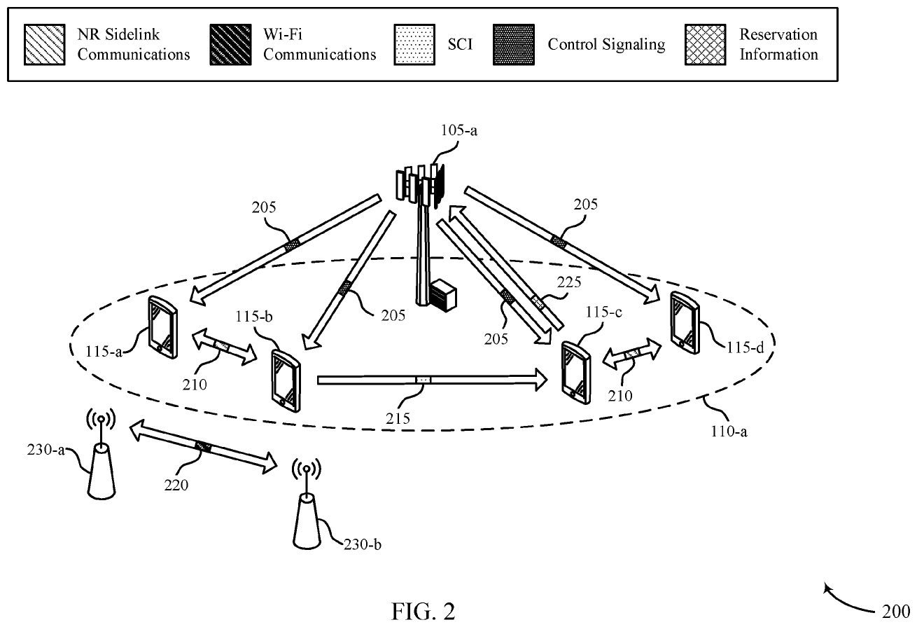

FIG. 2 illustrates an example of a wireless communications system 200 that supports resource reservation techniques for sidelink communications in accordance with one or more aspects of the present disclosure. The wireless communications system 200 may implement or be implemented by aspects of the wireless communications system 100. For example, the wireless communications system 200 may include a UE 115-a, a UE 115-b, a UE 115-c, a UE 115-d, and a network entity 105-a, which may be examples of corresponding devices described with reference to FIG. 1. The network entity 105-a may communicate with the UEs 115 within a coverage area 110-a, which may be an example of a coverage area 110, as described with reference to FIG. 1. The wireless communications system 200 may also include a wireless device 230-a and a wireless device 230-b, which may be examples of devices that support Wi-Fi communications 220. In the wireless communications system 200, the UE 115-b may reserve resources in a shared radio frequency spectrum band and use the reserved resources to perform sidelink communications 210 with the UE 115-a.

In the example of FIG. 2, the UE 115-b (e.g., a first sidelink UE) may select resources for an initial transmission and subsequent re-transmission in slots m₁ through m₅ (e.g., slots selected from a set of logical slots for sidelink communications, which may be discontinuous in time). If the UE 115-b experiences an LBT failure before transmission in slot m₃, the UE 115-b may be unable to perform sidelink transmissions in slot m₃. The UE 115-b may also be unable to reserve resources in slots m₄ and m₅. Thus, when the UE 115-c (e.g., a second sidelink UE) performs resource selection in slot m₃, the UE 115-c may not exclude the resources selected by the UE 115-b in slots m₄ and m₅ (since the UE 115-c did not receive SCI from the UE 115-b reserving these resources). Performing subsequent iterations of the resource selection procedure may cause delays (latency) when the UE 115-b is unable to successfully reserve resources. Although the UE 115-b may continue the LBT procedure in additional slots similar to load-based equipment (LBE) channel access procedures in 5 GHz unlicensed bands, these may be subject to increasing likelihood of collisions due to both Wi-Fi devices and other NR devices. If, for example, the UE 115-c selects resources that correspond to resources selected by the UE 115-b, the UE 115-b may experience signal collisions and poor communication reliability. In some cases, increasing the number of resources that can be reserved by one instance of SCI may help mitigate LBT failures. However, increasing the number of resources that can be reserved by SCI may affect the number of candidate resources that are available to other UEs. For example, if the UE 115-b finishes a transmission early, all remaining resources may be unused.

In accordance with aspects of the present disclosure, the UE 115-b may use mini-slot transmissions, earlier starting points (CPEs), resource reservation bursts, CAT 2 LBT-based SCI transmissions (following an LBT failure in a last reserved slot), and/or reservation forwarding techniques (for Mode 1 UEs) to improve the efficiency and reliability of sidelink communications 210 between the UE 115-b and the UE 115-a. Selection of one or more of mini-slot transmissions, earlier starting points, and resource reservation bursts can be based on surrounding interference levels. If the UE 115-b does not detect any Wi-Fi devices, using an earlier starting point (CPE) may be sufficient to deter other devices from using reserved resources. If the UE 115-b detects Wi-Fi devices, using a resource reservation burst may reduce the likelihood of the Wi-Fi devices interfering with the sidelink communications 210. The UE 115-a may indicate different combinations for each reserved resource via SCI. In some examples, the UE 115-b may use an earlier starting point for a first reserved resource, and may use a mini-slot transmission for a second reserved resource. Both an earlier starting point and a resource reservation burst can be used for the same reserved resource.

In some examples, Mode 1 UEs can forward reservation information to the network entity 105-a such that the network entity 105-a can coordinate resource utilization between the Mode 1 UEs. For example, if the UE 115-c receives SCI 215 that indicates resources reserved by the UE 115-b, the UE 115-c (e.g., a Mode 1 UE that received reservation information from the UE 115-b) may relay (e.g., forward) the reservation information 225 to the network entity 105-a. The network entity 105-a may not schedule SL-U transmissions during reserved slots or a quantity of preceding slots (e.g., that overlap with a scheduling gap reserved for LBT procedures at the UE 115-b) that could potentially block LBT procedures at the UE 115-b. The scheduling gap reserved for LBT procedures at the UE 115-b may depend on a maximum contention window size associated with a priority of the UE 115-b, a minimum contention window size associated with a priority of the UE 115-b, or a mean contention window size associated with a priority of the UE 115-b. Additionally or alternatively, the UE 115-b may signal a length of the LBT procedure (a current contention window size) for the UE 115-b. In such examples, the network entity 105-a may coordinate resource utilization between the UEs 115 by transmitting control signaling 205 to the UEs 115.

Aspects of the wireless communications system 200 may be implemented to realize one or more of the following advantages. The techniques described with reference to FIG. 2 may enable the UE 115-b (a wireless node operating in a shared radio frequency spectrum band) to transmit sidelink messages with fewer signal collisions, greater reliability, and higher throughput, among other benefits. For example, the UE 115-b may transmit a CPE via a wireless medium (e.g., a sub-channel of a shared radio frequency spectrum channel) prior to the start of a time slot in which the UE 115-b intends to transmit sidelink communications 210, which may reduce the probability of the wireless devices 230 using the wireless medium during the time slot. Moreover, if the UE 115-b determines that the wireless medium is occupied at the start of the time slot, the UE 115-b may still perform a mini-slot transmission within the time slot if the wireless medium becomes available during the time slot. As a result, the UE 115-b may perform the sidelink communications 210 with higher throughput and reduced latency.

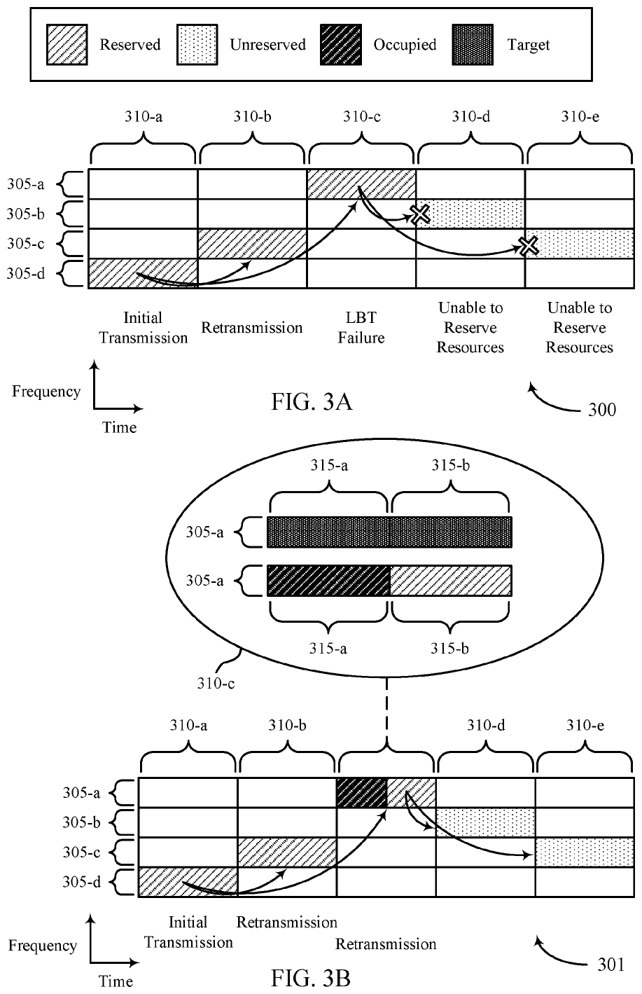

FIGS. 3A and 3B illustrate examples of a resource diagram 300 and a resource diagram 301 that support resource reservation techniques for sidelink communications in accordance with one or more aspects of the present disclosure. The resource diagram 300 and the resource diagram 301 may implement or be implemented by aspects of the wireless communications system 100 or the wireless communications system 200. For example, the resource diagram 300 and the resource diagram 301 may be implemented by a UE 115, as described with reference to FIGS. 1 and 2. The resource diagram 300 and the resource diagram 301 may include a sub-channel 305-a, a sub-channel 305-b, a sub-channel 305-c, and a sub-channel 305-d as well as a slot 310-a (slot m₁), a slot 310-b (slot m₂), a slot 310-c (slot m₃), a slot 310-d (slot m₄), and a slot 310-e (slot m₅). The illustrated slots may be logical slots allocated for sidelink communications of a slot structure used for both sidelink and non-sidelink communications. As illustrated in the example of FIG. 3B, a UE may perform a mini-slot transmission if a reserved slot is occupied at a slot boundary.

As described herein with reference to FIGS. 1 and 2, a UE may transmit SCI that indicates a set of resources reserved for sidelink communications at the UE. Each of the reserved resources may include a respective slot and a respective sub-channel of a shared radio frequency channel. The UE may perform an LBT procedure associated with a sub-channel of a reserved resource prior to accessing the reserved resource. In some examples, the UE may perform a mini-slot transmission if the LBT procedure is unsuccessful. In other examples, the UE may use a CPE to access the sub-channel before a start of the reserved resource. In some examples, the reserved resource may span two or more consecutive slots with the same sub-channel index. If, for example, the UE experiences an LBT failure prior to a last reserved slot, the UE may transmit a CAT 2 LBT-based SCI (which may be multiplexed with an S-SSB). If the UE supports Mode 1 resource selection (controlled by the network), the UE may forward reservation information for other UEs to the network.

The resource diagram 300 and the resource diagram 301 may support mini-slot transmissions during reserved slots in accordance with aspects of the present disclosure. In some examples, mini-slots can be used to provide additional channel access opportunities for retransmissions of sidelink messages. For example, if a wireless medium (a sub-channel of a shared radio frequency channel) is occupied (e.g., by a Wi-Fi device) at a slot boundary but the wireless medium is available (unoccupied) prior to a mini-slot boundary, an NR UE can use the mini-slot for retransmissions. For other SL-U links, the received signal power may increase at the mini-slot boundary (due to mini-slot transmissions from the NR UE). However, because the initial LBT procedure at the beginning of the slot was unsuccessful, there was likely other interference at the slot boundary, so the overall impact of mini-slot access for retransmissions may be nominal.

Mini-slot transmissions can be used in reserved slots to provide more transmission opportunities for a UE (e.g., the UE 115-b described with reference to FIG. 2). In some examples, all reserved slots may be available for mini-slot transmissions. In other examples, a last reserved slot may be available for mini-slot transmissions (as illustrated in the example of FIG. 3B). A transmitting UE can signal (via SCI) which reserved slots can be used for mini-slot transmissions. The techniques described herein may support using a sidelink resource pool with a mini-slot structure. UEs configured with the same resource pool may use the same mini-slot structure. A target UE (e.g., an intended recipient of a sidelink transmission) may attempt mini-slot detection, whereas other UEs may not attempt mini-slot detection.

In the example of FIG. 3A, the UE may perform an initial sidelink transmission using a first resource that includes the slot 310-a and the sub-channel 305-d. The initial sidelink transmission may include SCI that reserves a second resource and a third resource for subsequent communications at the UE. The second resource may include the slot 310-b and the sub-channel 305-c, while the third resource may include the slot 310-c and the sub-channel 305-a. The UE may perform a retransmission (of the initial sidelink transmission) using the second resource. In some examples, however, if the UE experiences an LBT failure prior to the third resource, the UE may be unable to reserve subsequent resources by transmitting SCI via the third resource.

In the example of FIG. 3B, the UE may perform an initial sidelink transmission using a first resource that includes the slot 310-a and the sub-channel 305-d. The initial sidelink transmission may include SCI that reserves a second resource and a third resource for subsequent communications at the UE. The second resource may include the slot 310-b and the sub-channel 305-c, while the third resource may include the slot 310-c and the sub-channel 305-a. The UE may perform a retransmission (of the initial sidelink transmission) using the second resource. If, for example, the UE detects that the sub-channel 305-a is occupied at a boundary of the slot 310-c, the UE may perform a subsequent LBT procedure at a mini-slot boundary within the slot 310-c. More specifically, if the sub-channel 305-a is occupied during a mini-slot 315-a, the UE may perform an LBT procedure at a boundary between the mini-slot 315-a and a mini-slot 315-b. If the LBT procedure is successful, the UE may perform a mini-slot transmission during the mini-slot 315-b, which may enable the UE to reserve subsequent resources for sidelink communications.

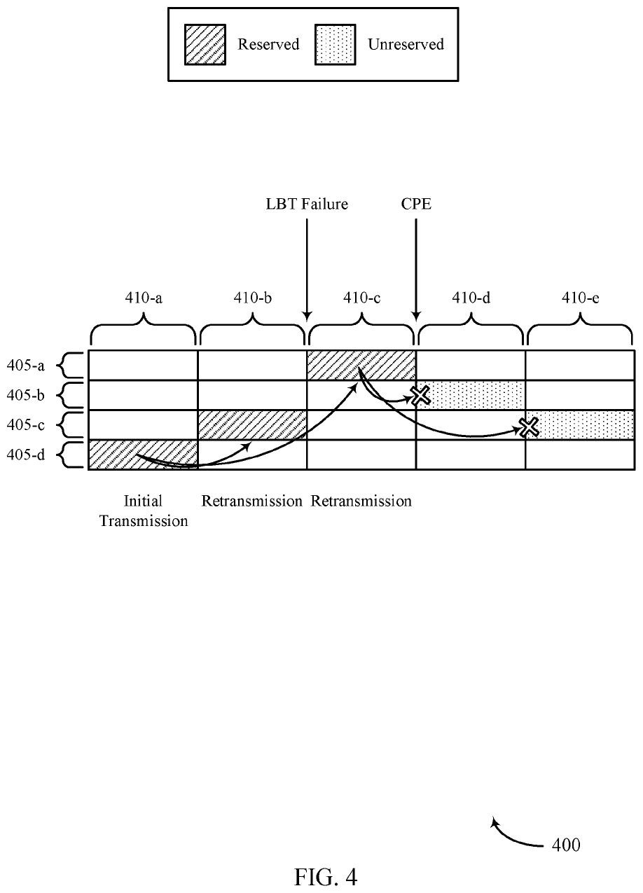

FIG. 4 illustrates an example of a resource diagram 400 that supports resource reservation techniques for sidelink communications in accordance with one or more aspects of the present disclosure. The resource diagram 400 may implement or be implemented by aspects of the wireless communications system 100 or the wireless communications system 200. For example, the resource diagram 400 may be implemented by a UE 115, as described with reference to FIGS. 1 and 2. The resource diagram 400 may include a sub-channel 405-a, a sub-channel 405-b, a sub-channel 405-c, and a sub-channel 405-d as well as a slot 410-a (slot m₁), a slot 410-b (slot m₂), a slot 410-c (slot m₃), a slot 410-d (slot m₄), and a slot 410-e (slot m₅). As illustrated in the resource diagram 400, a UE may transmit a sidelink message with a CPE via resources in a shared radio frequency spectrum band. Transmitting the sidelink message with a CPE may enable the UE to access a wireless medium (e.g., a shared radio frequency spectrum channel) prior to a time slot in which other NR devices may access the time slot, thereby reducing the likelihood of transmissions from other devices (e.g., other NR devices) colliding with the sidelink message from the UE.

As described herein with reference to FIGS. 1 through 3, a UE may transmit SCI that indicates a set of resources reserved for sidelink communications at the UE. Each of the reserved resources may include a respective slot and a respective sub-channel of a shared radio frequency channel. The UE may perform an LBT procedure associated with a sub-channel of a reserved resource prior to accessing the reserved resource. In some examples, the UE may perform a mini-slot transmission if the LBT procedure is unsuccessful. In other examples, the UE may use a CPE to access the sub-channel before a start of the reserved resource. In some examples, the reserved resource may span two or more consecutive slots with the same sub-channel index. If, for example, the UE experiences an LBT failure prior to a last reserved slot, the UE may transmit a CAT 2 LBT-based SCI (which may be multiplexed with an S-SSB). Multiplexing the SCI with the S-SSB may allow the UE to transmit the SCI using a CAT 2 LBT because S-SSB with CAT-2 LBT may be permitted over the channel. If the UE supports Mode 1 resource selection (controlled by the network), the UE may forward reservation information for other UEs to the network.

The resource diagram 400 may support transmission of CPEs during (or prior to) reserved resources in accordance with examples described herein. To prioritize retransmissions of sidelink messages, an earlier starting point (also referred to as a CPE) can be used to access a wireless medium prior to the beginning of a reserved slot. In some examples, a UE can use an earlier starting point in any reserved slot. In other examples, the UE may be limited to using an earlier starting point in a last slot reserved by the UE. If a transmitting UE intends to use an earlier starting point in one or more reserved slots, the transmitting UE can indicate these slots via SCI. Use of a CPE may correspond to offset of the LBT procedure associated with a slot. For example, the LBT procedure may be moved up in time by the CPE and may be performed prior to the CPE such that devices (e.g., other NR UEs) performing LBT prior to the slot may detect that the sub-channel is busy for the slot.

Additionally or alternatively, a transmitting UE can indicate (via SCI) one or more candidate slots (for subsequent retransmissions) in which the transmitting UE intends to use an earlier starting point. For example, if the transmitting UE intends to use an earlier starting point for slot m₃+k, the transmitting UE may indicate this slot via SCI. In the example of FIG. 4, slot m₃+k may refer to the slot 410-d. If the transmitting UE fails to reserve slots for subsequent retransmissions, the transmitting UE can use slot m₃+k for retransmissions. The earlier starting point can help reduce the probability of collisions with other UEs. Different CPE values (durations) can be defined or configured via RRC signaling. For example, multiple CPE values may be configured via RRC signaling, and the UE may select one of the multiple configured CPE values for a given slot or transmission. The transmitting UE can select one of the configured or defined CPE values based on traffic priority (e.g., priority level of the sidelink message).

In the example of FIG. 4, a UE may perform an initial sidelink transmission using a first resource that includes a slot 410-a and a sub-channel 405-d of a shared radio frequency channel. The initial sidelink transmission may include SCI that reserves a second resource and a third resource for sidelink communications at the UE. The second resource may include the slot 410-b and the sub-channel 405-c, while the second resource may include the slot 410-c and the sub-channel 405-a. The UE may perform a retransmission of the initial sidelink transmission using the second resource. In some examples, however, if the UE experiences an LBT failure before the slot 410-c, the UE may be unable to reserve a fourth resource (the slot 410-d and the sub-channel 405-b) by transmitting SCI via the third resource. In such examples, the UE may reduce the likelihood of other devices using the fourth resource by transmitting a CPE prior to the slot 410-d (e.g., by accessing the wireless medium earlier). As a result, the UE may use the fourth resource for sidelink communications.

Aspects of the resource diagram 400 may be implemented to realize one or more of the following advantages. The techniques described with reference to FIG. 4 may enable a UE operating in a shared radio frequency spectrum band to transmit sidelink messages with fewer signal collisions, greater reliability, and higher throughput, among other benefits. For example, a UE may transmit a CPE via a wireless medium prior to the start of a time slot in which the UE intends to transmit a sidelink message, which may reduce the probability of other devices (e.g., Wi-Fi devices) using the wireless medium during the time slot. Moreover, if the UE determines that the wireless medium is occupied at the start of the time slot, the UE may still perform a mini-slot transmission within the time slot if the wireless medium becomes available during the time slot (as described with reference to FIGS. 3A and 3B). As a result, the UE may perform sidelink communications with higher throughput and reduced latency.

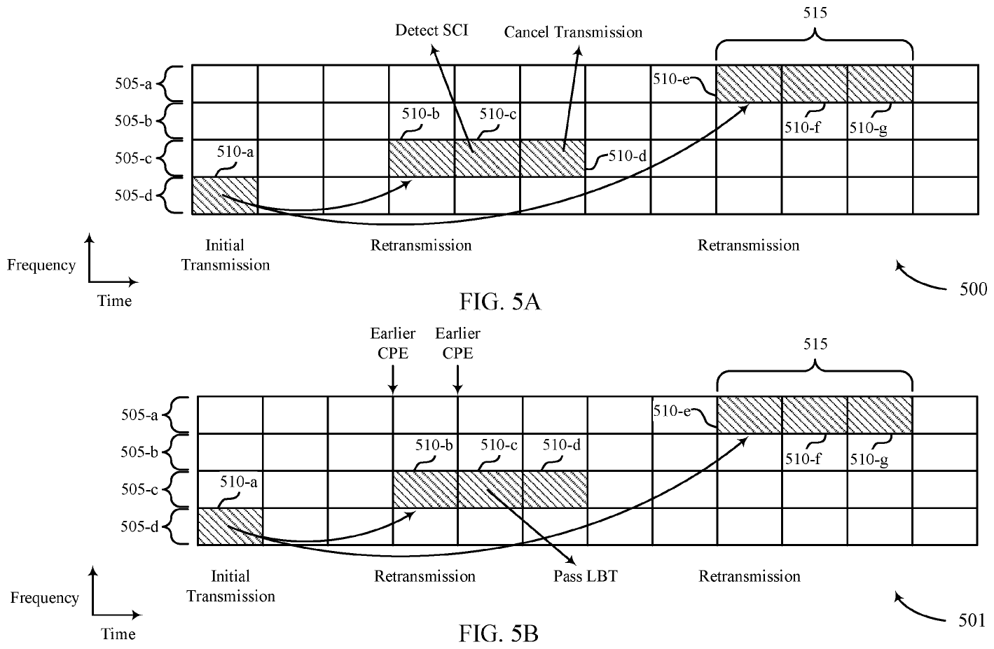

FIGS. 5A and 5B illustrate examples of a resource diagram 500 and a resource diagram 501 that support resource reservation techniques for sidelink communications in accordance with one or more aspects of the present disclosure. The resource diagram 500 and the resource diagram 501 may implement or be implemented by aspects of the wireless communications system 100 or the wireless communications system 200. For example, the resource diagram 500 and the resource diagram 501 may be implemented by a UE 115, as described with reference to FIGS. 1 and 2. The resource diagram 500 may include a sub-channel 505-a, a sub-channel 505-b, a sub-channel 505-c, and a sub-channel 505-d as well as a slot 510-a, a slot 510-b, a slot 510-c, a slot 510-d, a slot 510-e, a slot 510-f, and a slot 510-g. As illustrated in FIGS. 5A and 5B, a UE may reserve one or more bursts of consecutive resources (e.g., each associated with the same sub-channel) via a single instance of SCI.

The resource diagram 500 and the resource diagram 501 may support techniques for reserving a burst of consecutive resources (equivalently referred to as a reservation burst) with the same sub-channel index in accordance with examples described herein. To provide multiple opportunities for subsequent transmissions, a reservation burst can be used to reserve multiple consecutive (continuous) slots. A transmitting UE can use a slot in the reservation burst to perform re-transmissions after a successful LBT procedure. In SL-U, a transmitting UE can reserve a quantity of slots (K) with the same sub-channel index for one transmission. In some examples, K can be pre-configured. In other examples, K can be indicated via RRC signaling. Additionally or alternatively, K can be indicated via SCI (from the transmitting UE). In the example of FIGS. 5A and 5B, the value of K may be 3. However, it is to be understood that K may have different values in different scenarios.

When using reservation bursts, other devices may recover (recycle, re-allocate) unused resources from the reservation burst. In some examples, other UEs may perform SCI detection during resources in the reservation burst. If a receiving UE detects SCI from the transmitting UE in these resources, the receiving UE may consider remaining resources in the reservation burst cancelled (not occupied by the transmitting UE, available). Alternatively, sidelink UEs can use different starting points within the reservation burst. In slots used for retransmissions, an earlier starting point (CPE) can be used to prioritize the retransmission, as described with reference to FIG. 4.

In the example of FIG. 5A, the UE may perform an initial sidelink transmission using a first resource that includes the slot 510-a and the sub-channel 505-d. The initial sidelink transmission may include SCI that reserves multiple consecutive resources (a reservation burst) for subsequent communications at the UE. For example, the initial sidelink transmission may reserve a burst of resources that includes the slot 510-b, the slot 510-c, the slot 510-d, and the sub-channel 505-c (e.g., multiple consecutive resources associated with the same sub-channel). The initial sidelink transmission may also reserve a burst of resources 515 that includes the slot 510-e, the slot 510-f, the slot 510-g, and the sub-channel 505-a. In some examples, the UE may use the burst of resources 515 to retransmit the initial sidelink transmission. If the UE is able to transmit the sidelink transmission in slot 510-c, the UE may suppress transmissions for slot 510-d. Other UEs that detect SCI from the UE during the slot 510-c may assume that the UE will not transmit in slot 510-d, and may contend for the slot.

In the example of FIG. 5B, the UE may perform an initial sidelink transmission using a first resource that includes the slot 510-a and the sub-channel 505-d. The initial sidelink transmission may include SCI that reserves multiple consecutive resources (a reservation burst) for subsequent communications at the UE. For example, the initial sidelink transmission may reserve a burst of resources that includes the slot 510-b, the slot 510-c, the slot 510-d, and the sub-channel 505-c (e.g., multiple consecutive resources associated with the same sub-channel). The initial sidelink transmission may also reserve a burst of resources 515 that includes the slot 510-e, the slot 510-f, the slot 510-g, and the sub-channel 505-a.

In some examples, the UE may use the burst of resources 515 to retransmit the initial sidelink transmission. As described with reference to FIG. 4, the UE may use an earlier CPE to access the sub-channel 505-c prior to the slot 510-b and an earlier CPE to access the sub-channel 505-c prior to the slot 510-c. Accessing the sub-channel 505-c early may deter other devices (e.g., Wi-Fi devices) from using the sub-channel 505-c during these slots 510. If the UE performs a successful LBT procedure prior to the slot 510-c, the UE may use the slot 510-c for sidelink communications and may suppress transmissions for slot 510-d (e.g., any remaining slots in the reservation burst). Thus, if the UE has no data to transmit during the slot 510-d, the UE may not need to use a CPE to access the sub-channel 505-c prior to the slot 510-d.

Aspects of the resource diagram 500 and the resource diagram 501 may be implemented to realize one or more of the following advantages. The techniques described with reference to FIGS. 5A and 5B may enable a UE operating in a shared radio frequency spectrum band to transmit sidelink messages with fewer signal collisions, greater reliability, and higher throughput, among other benefits. For example, a UE may transmit a CPE via a wireless medium prior to the start of a time slot in which the UE intends to transmit a sidelink message, which may reduce the probability of other devices (e.g., Wi-Fi devices) using the wireless medium during the time slot. Moreover, the techniques described herein may enable the UE to reserve a burst of consecutive resources via one instance of SCI, which may enable the UE to perform multiple retransmissions of a sidelink message.

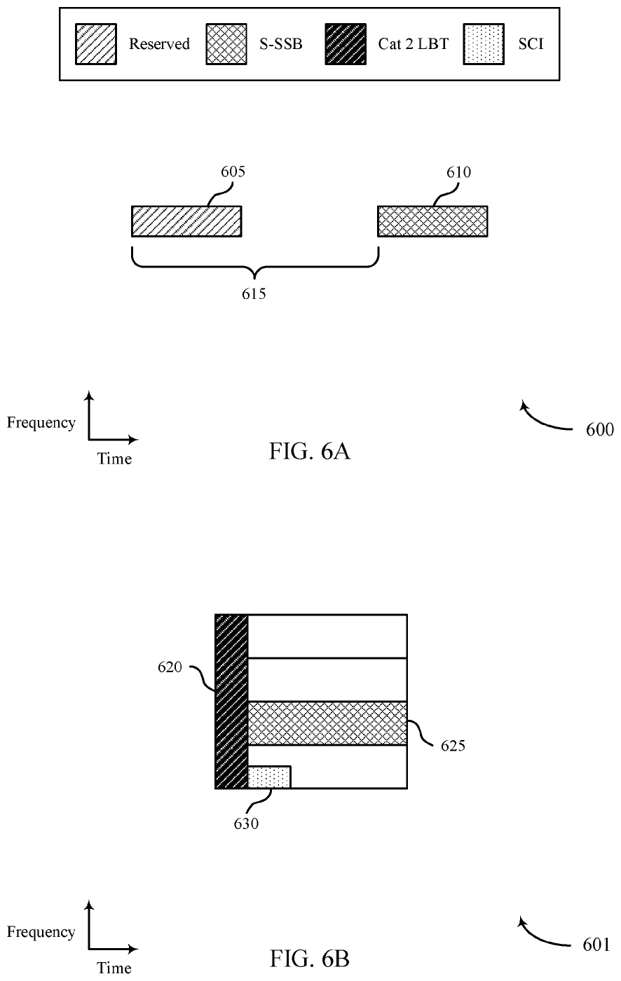

FIGS. 6A and 6B illustrate examples of a resource diagram 600 and a resource diagram 601 that support resource reservation techniques for sidelink communications in accordance with one or more aspects of the present disclosure. The resource diagram 600 and the resource diagram 601 may implement or be implemented by aspects of the wireless communications system 100 or the wireless communications system 200. For example, the resource diagram 600 and the resource diagram 601 may be implemented by a UE 115, as described with reference to FIGS. 1 and 2. The resource diagram 600 may include a reserved resource 605, an S-SSB transmission occasion 610, and a time duration 615 between a start of the reserved resource 605 and a start of the S-SSB transmission occasion 610. The resource diagram 601 may include a CAT 2 LBT procedure 620, an S-SSB 625, and SCI 630., as described herein, a UE may transmit CAT 2 LBT-based SCI if the UE experiences an LBT failure in a last slot reserved for sidelink communications at the UE. Because the channel may allow synchronization signals with increased priority (e.g., CAT 2 LBT), the UE may transmit the CAT 2 LBT-based S-SSB, and transmit the SCI with the S-SSB.

As described herein with reference to FIGS. 1 through 5, a UE may transmit SCI that indicates a set of resources reserved for sidelink communications at the UE. Each of the reserved resources may include a respective slot and a respective sub-channel of a shared radio frequency channel. The UE may perform an LBT procedure associated with a sub-channel of a reserved resource prior to accessing the reserved resource. In some examples, the UE may perform a mini-slot transmission if the LBT procedure is unsuccessful. In other examples, the UE may use a CPE to access the sub-channel before a start of the reserved resource. In some examples, the reserved resource may span two or more consecutive slots with the same sub-channel index. If, for example, the UE experiences an LBT failure prior to a last reserved slot, the UE may transmit a CAT 2 LBT-based SCI (which may be multiplexed with an S-SSB). If the UE supports Mode 1 resource selection (controlled by the network), the UE may forward reservation information for other UEs to the network.

The resource diagram 600 and the resource diagram 601 may support techniques for transmitting SCI (after an LBT failure during a last reserved slot) in accordance with a CAT 2 LBT procedure. In some examples, if an LBT failure occurs before the last reserved slot, the UE can transmit a CAT 2 S-SSB and multiplex SCI-1 with the S-SSB to reserve subsequent resources. The UE may, in some examples, transmit the S-SSB using resources from a sidelink resource pool (e.g., logical slots allocated for sidelink communications). In some cases, S-SSBs may have network-configured locations. If a network-configured S-SSB location (resources reserved for transmission of an S-SSB) is sufficiently close to the last reserved slot, the UE can use that S-SSB location for transmission of the SCI-1. The gap between the last reserved slot and a valid S-SSB location can be defined or configured via RRC signaling. In some examples, a denser S-SSB configuration may be preferable for SCI transmission. If the SCI-1 is FDM-ed with the S-SSB, the resulting signal may be transmitted in a defined location within the slot such that other UEs can decode the resulting signal. Alternatively, If the UE is unable to pass the LBT procedure before the last reserved slot, the UE can perform a CAT 2 LBT procedure and transmit SCI-1 instead (e.g., without transmitting S-SSB).

In the example of FIG. 6A, the UE may perform an LBT procedure prior to a slot of the reserved resource 605. If the LBT procedure is unsuccessful, the UE may be unable to reserve subsequent resources by transmitting SCI during the slot. However, if the time duration 615 between a start of the reserved resource 605 and a start of the S-SSB transmission occasion 610 is below a threshold (e.g., if the time duration 615 is less than or equal to a gap period), the UE may reserve additional resources by transmitting SCI-1 (potentially multiplexed with an S-SSB) during the S-SSB transmission occasion 610 in accordance with a CAT 2 LBT procedure. In the example of FIG. 6B, the UE may perform the CAT 2 LBT procedure 620 prior to transmitting the S-SSB 625., as described herein, the UE may FDM the SCI 630 with the S-SSB 625. The SCI 630 may enable the UE to reserve subsequent resources for sidelink communications.

Aspects of the resource diagram 600 and the resource diagram 601 may be implemented to realize one or more of the following advantages. The techniques described with reference to FIGS. 6A and 6B may enable a UE operating in a shared radio frequency spectrum band to transmit sidelink messages with fewer signal collisions, greater reliability, and higher throughput, among other benefits. For example, a UE may transmit a CPE via a wireless medium prior to the start of a time slot in which the UE intends to transmit a sidelink message, which may reduce the probability of other devices (e.g., Wi-Fi devices) using the wireless medium during the time slot. Moreover, if the UE experiences an LBT failure prior to a last reserved slot, the UE may transmit a CAT 2 LBT-based SCI (possibly multiplexed with the S-SSB 625) to reserve subsequent resources for sidelink communications.

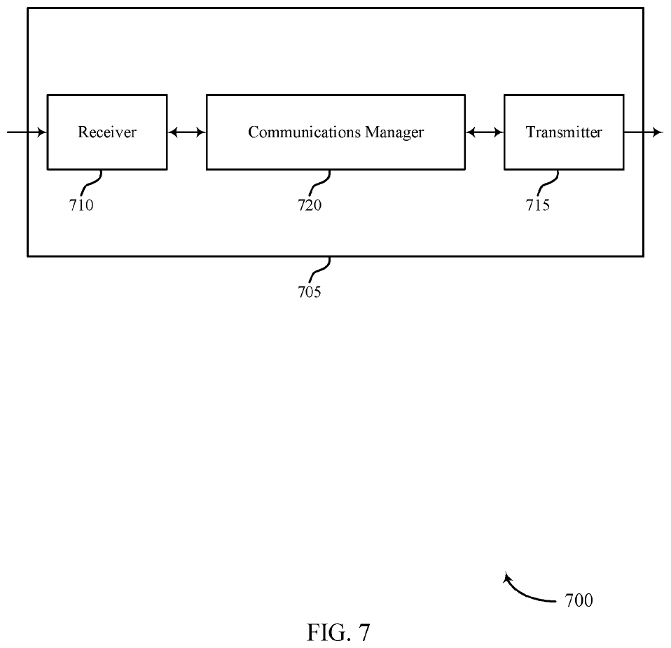

FIG. 7 shows a block diagram 700 of a device 705 that supports resource reservation techniques for sidelink communications in accordance with one or more aspects of the present disclosure. The device 705 may be an example of aspects of a UE 115, as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to resource reservation techniques for sidelink communications). Information may be passed on to other components of the device 705. The receiver 710 may utilize a single antenna or multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to resource reservation techniques for sidelink communications). In some examples, the transmitter 715 may be co-located with a receiver 710 in a transceiver module. The transmitter 715 may utilize a single antenna or multiple antennas.

The communications manager 720, the receiver 710, the transmitter 715, or various combinations thereof or various components thereof may be examples of means for performing various aspects of resource reservation techniques for sidelink communications, as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations, as described herein.

The communications manager 720 may support wireless communications at the device 705 in accordance with examples disclosed herein. For example, the communications manager 720 may be configured as or otherwise support a means for transmitting SCI that indicates a set of reserved resources for sidelink communications at the device 705, each of the set of reserved resources including a respective slot of multiple slots and a respective sub-channel of a shared radio frequency channel that includes multiple sub-channels. The communications manager 720 may be configured as or otherwise support a means for determining that a sub-channel of a reserved resource is occupied at a beginning of a slot of the reserved resource based on performing a first LBT procedure prior to the slot. The communications manager 720 may be configured as or otherwise support a means for transmitting, via the sub-channel of the reserved resource, a sidelink message during a mini-slot of the reserved resource based on performing a second LBT procedure prior to the mini-slot, where the mini-slot begins after the beginning of the slot.

Additionally, or alternatively, the communications manager 720 may support wireless communications at the device 705 in accordance with other examples disclosed herein. For example, the communications manager 720 may be configured as or otherwise support a means for transmitting SCI that indicates a set of reserved resources for sidelink communications at the device 705, each of the set of reserved resources including a respective slot of multiple slots and a respective sub-channel of a shared radio frequency channel that includes multiple sub-channels. The communications manager 720 may be configured as or otherwise support a means for performing a LBT procedure associated with a sub-channel of a reserved resource prior to a slot of the reserved resource. The communications manager 720 may be configured as or otherwise support a means for transmitting a sidelink message with a CPE via the sub-channel of the reserved resource based on a result of the LBT procedure, where transmission of the CPE begins prior to the slot of the reserved resource.

Additionally, or alternatively, the communications manager 720 may support wireless communications at the device 705 in accordance with other examples disclosed herein. For example, the communications manager 720 may be configured as or otherwise support a means for transmitting first SCI that indicates a set of reserved resources for sidelink communications at the device 705, each of the set of reserved resources including a respective slot of multiple slots and a respective sub-channel of a shared radio frequency channel that includes multiple sub-channels. The communications manager 720 may be configured as or otherwise support a means for determining that a sub-channel of a reserved resource is occupied during a first slot of the reserved resource based on performing a first LBT procedure prior to the first slot. The communications manager 720 may be configured as or otherwise support a means for transmitting a sidelink message in a second slot based on performing a second LBT procedure prior to the second slot, where the second slot is based on the first slot.

Additionally, or alternatively, the communications manager 720 may support wireless communications at the device 705 (a first UE) in accordance with examples disclosed herein. For example, the communications manager 720 may be configured as or otherwise support a means for receiving SCI that indicates a first set of reserved resources for sidelink communications at a second UE, each resource in the first set of reserved resources including a respective slot of multiple slots and a respective sub-channel of a shared radio frequency channel that includes multiple sub-channels. The communications manager 720 may be configured as or otherwise support a means for transmitting an indication of the first set of reserved resources to a network entity based on a resource selection mode of the device 705. The communications manager 720 may be configured as or otherwise support a means for receiving control signaling that indicates a second set of reserved resources for sidelink communications by the device 705, where the first set of reserved resources for the second UE is different from the second set of reserved resources for the device 705.

By including or configuring the communications manager 720 in accordance with examples, as described herein, the device 705 (e.g., a processor controlling or otherwise coupled with the receiver 710, the transmitter 715, the communications manager 720, or a combination thereof) may support techniques for more efficient utilization of communication resources by enabling the device 705 to reserve resources (for sidelink communications in an unlicensed or shared radio frequency spectrum band) with greater efficiency.

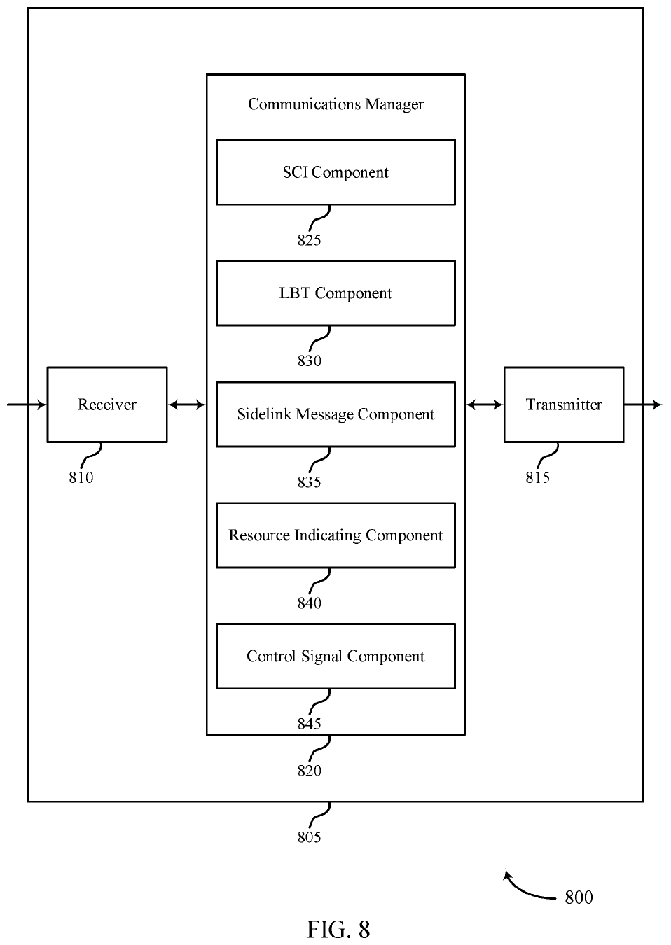

FIG. 8 shows a block diagram 800 of a device 805 that supports resource reservation techniques for sidelink communications in accordance with one or more aspects of the present disclosure. The device 805 may be an example of aspects of a device 705 or a UE 115, as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to resource reservation techniques for sidelink communications). Information may be passed on to other components of the device 805. The receiver 810 may utilize a single antenna or multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to resource reservation techniques for sidelink communications). In some examples, the transmitter 815 may be co-located with a receiver 810 in a transceiver module. The transmitter 815 may utilize a single antenna or multiple antennas.

The device 805, or various components thereof, may be an example of means for performing various aspects of resource reservation techniques for sidelink communications, as described herein. For example, the communications manager 820 may include an SCI component 825, an LBT component 830, a sidelink message component 835, a resource indicating component 840, a control signal component 845, or any combination thereof. The communications manager 820 may be an example of aspects of a communications manager 720, as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations, as described herein.

The communications manager 820 may support wireless communications at the device 805 in accordance with examples disclosed herein. The SCI component 825 may be configured as or otherwise support a means for transmitting SCI that indicates a set of reserved resources for sidelink communications at the device 805, each of the set of reserved resources including a respective slot of multiple slots and a respective sub-channel of a shared radio frequency channel that includes multiple sub-channels. The LBT component 830 may be configured as or otherwise support a means for determining that a sub-channel of a reserved resource is occupied at a beginning of a slot of the reserved resource based on performing a first LBT procedure prior to the slot. The sidelink message component 835 may be configured as or otherwise support a means for transmitting, via the sub-channel of the reserved resource, a sidelink message during a mini-slot of the reserved resource based on performing a second LBT procedure prior to the mini-slot, where the mini-slot begins after the beginning of the slot.

Additionally, or alternatively, the communications manager 820 may support wireless communications at the device 805 in accordance with other examples disclosed herein. The SCI component 825 may be configured as or otherwise support a means for transmitting SCI that indicates a set of reserved resources for sidelink communications at the device 805, each of the set of reserved resources including a respective slot of multiple slots and a respective sub-channel of a shared radio frequency channel that includes multiple sub-channels. The LBT component 830 may be configured as or otherwise support a means for performing a LBT procedure associated with a sub-channel of a reserved resource prior to a slot of the reserved resource. The sidelink message component 835 may be configured as or otherwise support a means for transmitting a sidelink message with a CPE via the sub-channel of the reserved resource based on a result of the LBT procedure, where transmission of the CPE begins prior to the slot of the reserved resource.

Additionally, or alternatively, the communications manager 820 may support wireless communications at the device 805 in accordance with other examples disclosed herein. The SCI component 825 may be configured as or otherwise support a means for transmitting first SCI that indicates a set of reserved resources for sidelink communications at the device 805, each of the set of reserved resources including a respective slot of multiple slots and a respective sub-channel of a shared radio frequency channel that includes multiple sub-channels. The LBT component 830 may be configured as or otherwise support a means for determining that a sub-channel of a reserved resource is occupied during a first slot of the reserved resource based on performing a first LBT procedure prior to the first slot. The sidelink message component 835 may be configured as or otherwise support a means for transmitting a sidelink message in a second slot based on performing a second LBT procedure prior to the second slot, where the second slot is based on the first slot.

Additionally, or alternatively, the communications manager 820 may support wireless communications at the device 805 (a first UE) in accordance with other examples disclosed herein. The SCI component 825 may be configured as or otherwise support a means for receiving SCI that indicates a first set of reserved resources for sidelink communications at a second UE, each resource in the first set of reserved resources including a respective slot of multiple slots and a respective sub-channel of a shared radio frequency channel that includes multiple sub-channels. The resource indicating component 840 may be configured as or otherwise support a means for transmitting an indication of the first set of reserved resources to a network entity based on a resource selection mode of the device 805. The control signal component 845 may be configured as or otherwise support a means for receiving control signaling that indicates a second set of reserved resources for sidelink communications by the device 805, where the first set of reserved resources for the second UE is different from the second set of reserved resources for the device 805.

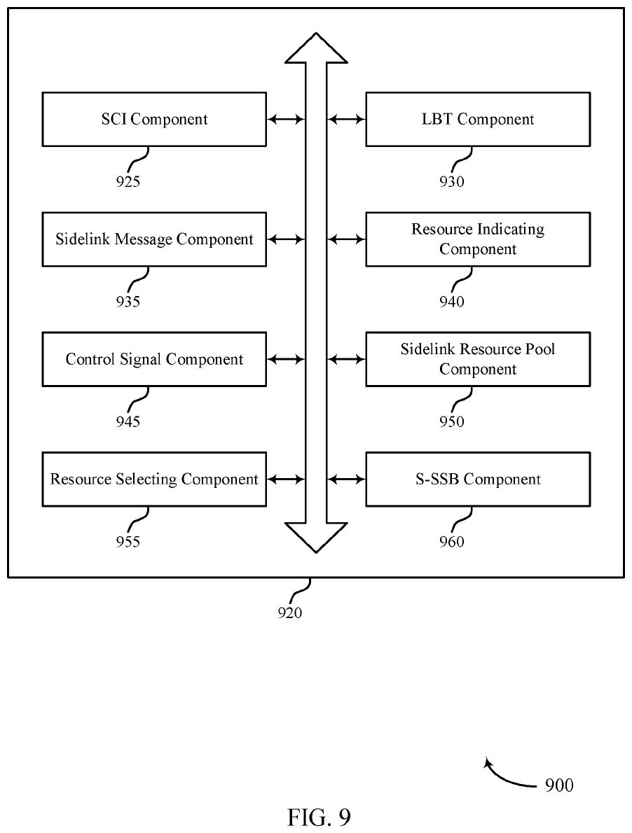

FIG. 9 shows a block diagram 900 of a communications manager 920 that supports resource reservation techniques for sidelink communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of resource reservation techniques for sidelink communications, as described herein. For example, the communications manager 920 may include an SCI component 925, an LBT component 930, a sidelink message component 935, a resource indicating component 940, a control signal component 945, a sidelink resource pool component 950, a resource selecting component 955, an S-SSB component 960, or any combination thereof. Each of these components may communicate, directly or indirectly, with one another (e.g., via one or more buses).

The communications manager 920 may support wireless communications at a UE in accordance with examples disclosed herein. The SCI component 925 may be configured as or otherwise support a means for transmitting SCI that indicates a set of reserved resources for sidelink communications at the UE, each of the set of reserved resources including a respective slot of multiple slots and a respective sub-channel of a shared radio frequency channel that includes multiple sub-channels. The LBT component 930 may be configured as or otherwise support a means for determining that a sub-channel of a reserved resource is occupied at a beginning of a slot of the reserved resource based on performing a first LBT procedure prior to the slot. The sidelink message component 935 may be configured as or otherwise support a means for transmitting, via the sub-channel of the reserved resource, a sidelink message during a mini-slot of the reserved resource based on performing a second LBT procedure prior to the mini-slot, where the mini-slot begins after the beginning of the slot.

In some examples, the reserved resource is a first reserved resource that is prior to a second reserved resource of the set of reserved resources. In some examples, transmitting the sidelink message during the mini-slot of the reserved resource is based on the reserved resource being a last reserved resource of the set of reserved resources. In some examples, the SCI indicates one or more of the set of reserved resources that are available for mini-slot transmissions.

In some examples, the sidelink resource pool component 950 may be configured as or otherwise support a means for receiving an indication of a sidelink resource pool with a mini-slot structure. In some examples, the sidelink resource pool component 950 may be configured as or otherwise support a means for selecting the set of reserved resources from the sidelink resource pool based on a resource selection mode of the UE.

In some examples, the set of reserved resources includes a second reserved resource that occurs prior to the reserved resource, and the LBT component 930 may be configured as or otherwise support a means for performing a third LBT procedure prior to a second slot associated with the second reserved resource, where the third LBT procedure completes an offset prior to the second slot. In some examples, the SCI indicates respective channel access modifications for each of the set of reserved resources. In some examples, the respective channel access modifications for the reserved resource includes a mini-slot channel access.

Additionally, or alternatively, the communications manager 920 may support wireless communications at a UE in accordance with other examples disclosed herein. In some examples, the SCI component 925 may be configured as or otherwise support a means for transmitting SCI that indicates a set of reserved resources for sidelink communications at the UE, each of the set of reserved resources including a respective slot of multiple slots and a respective sub-channel of a shared radio frequency channel that includes multiple sub-channels. In some examples, the LBT component 930 may be configured as or otherwise support a means for performing a LBT procedure associated with a sub-channel of a reserved resource prior to a slot of the reserved resource. In some examples, the sidelink message component 935 may be configured as or otherwise support a means for transmitting a sidelink message with a CPE via the sub-channel of the reserved resource based on a result of the LBT procedure, where transmission of the CPE begins prior to the slot of the reserved resource.

In some examples, the reserved resource is a first reserved resource that is prior to a second reserved resource of the set of reserved resources. In some examples, transmitting the sidelink message with the CPE is based on the reserved resource being a last reserved resource of the set of reserved resources. In some examples, the SCI indicates one or more of the set of reserved resources that are available for sidelink transmissions with CPEs.

In some examples, the SCI indicates an offset for a candidate slot from the slot for retransmission of the sidelink message. In some examples, the control signal component 945 may be configured as or otherwise support a means for receiving RRC signaling that indicates one or more possible durations of the CPE. In some examples, a duration of the CPE is based on a priority level of the sidelink message.

In some examples, to support transmitting the sidelink message with the CPE, the LBT component 930 may be configured as or otherwise support a means for determining that use of the sub-channel by devices associated with a second RAT fails to satisfy a threshold.

Additionally, or alternatively, the communications manager 920 may support wireless communications at a UE in accordance with other examples disclosed herein. In some examples, the SCI component 925 may be configured as or otherwise support a means for transmitting first SCI that indicates a set of reserved resources for sidelink communications at the UE, each of the set of reserved resources including a respective slot of multiple slots and a respective sub-channel of a shared radio frequency channel that includes multiple sub-channels. In some examples, the LBT component 930 may be configured as or otherwise support a means for determining that a sub-channel of a reserved resource is occupied during a first slot of the reserved resource based on performing a first LBT procedure prior to the first slot. In some examples, the sidelink message component 935 may be configured as or otherwise support a means for transmitting a sidelink message in a second slot based on performing a second LBT procedure prior to the second slot, where the second slot is based on the first slot.

In some examples, each of the set of reserved resources includes a respective multiple consecutive slots and a respective sub-channel of a shared radio frequency channel that includes multiple sub-channels. In some examples, the respective multiple consecutive slots for the reserved resource includes the first slot and the second slot.

In some examples, the LBT component 930 may be configured as or otherwise support a means for suppressing performing additional LBT procedures to access the sub-channel for remaining slots of the respective multiple consecutive slots of the reserved resource subsequent to the second slot.

In some examples, the control signal component 945 may be configured as or otherwise support a means for receiving RRC signaling that indicates a quantity of the respective multiple consecutive slots the UE can reserve for each of the set of reserved resources. In some examples, the resource selecting component 955 may be configured as or otherwise support a means for selecting the set of reserved resources for transmission of the sidelink message based on the RRC signaling. In some examples, the first SCI indicates a quantity of the respective multiple consecutive slots in each of the set of reserved resources.

In some examples, the SCI component 925 may be configured as or otherwise support a means for receiving second SCI that indicates a second set of reserved resources for sidelink communications by a second UE, each of the second set of reserved resources including a respective multiple consecutive slots and a respective sub-channel of the shared radio frequency channel. In some examples, the SCI component 925 may be configured as or otherwise support a means for receiving third SCI from the second UE in a first slot of the respective multiple consecutive slots of a second reserved resource of the second set of reserved resources. In some examples, the LBT component 930 may be configured as or otherwise support a means for performing a second LBT procedure for access to a corresponding sub-channel of the second reserved resource prior to a second slot of the respective multiple consecutive slots of the second reserved resource based on receiving the third SCI.

In some examples, to support transmitting the sidelink message, the sidelink message component 935 may be configured as or otherwise support a means for transmitting the sidelink message with a CPE via the sub-channel of the reserved resource based on a result of the second LBT procedure, where transmission of the CPE begins prior to the second slot of the reserved resource. In some examples, the sidelink message includes a retransmission of a first message. In some examples, the first SCI and the first message are transmitted in a third slot that precedes the first slot.

In some examples, the sidelink message includes second SCI, and the SCI component 925 may be configured as or otherwise support a means for multiplexing the second SCI with an S-SSB in the second slot.

In some examples, the second SCI indicates a second set of reserved resources for sidelink communications by the UE. In some examples, the first LBT procedure is a first type of LBT procedure and the second LBT procedure is a second type of LBT procedure.

In some examples, to support transmitting the second SCI, the S-SSB component 960 may be configured as or otherwise support a means for transmitting the S-SSB via resources of a sidelink resource pool.

In some examples, to support transmitting the second SCI, the SCI component 925 may be configured as or otherwise support a means for transmitting the second SCI multiplexed with the S-SSB based on a time gap between a last slot of the set of reserved resources and the second slot. In some examples, a duration of the time gap is configured via RRC signaling. In some examples, the second SCI is FDM-ed with the S-SSB.

Additionally, or alternatively, the communications manager 920 may support wireless communications at a first UE in accordance with other examples disclosed herein. In some examples, the SCI component 925 may be configured as or otherwise support a means for receiving SCI that indicates a first set of reserved resources for sidelink communications at a second UE, each resource in the first set of reserved resources including a respective slot of multiple slots and a respective sub-channel of a shared radio frequency channel that includes multiple sub-channels. The resource indicating component 940 may be configured as or otherwise support a means for transmitting an indication of the first set of reserved resources to a network entity based on a resource selection mode of the UE. The control signal component 945 may be configured as or otherwise support a means for receiving control signaling that indicates a second set of reserved resources for sidelink communications by the UE, where the first set of reserved resources for the second UE is different from the second set of reserved resources for the UE.

In some examples, the LBT component 930 may be configured as or otherwise support a means for receiving a message that indicates a duration of a LBT procedure, a contention window size of the second UE, or both. In some examples, the resource indicating component 940 may be configured as or otherwise support a means for signaling one or both of the contention window size of the second UE or the duration of the LBT procedure to the network entity based on the resource selection mode of the UE.

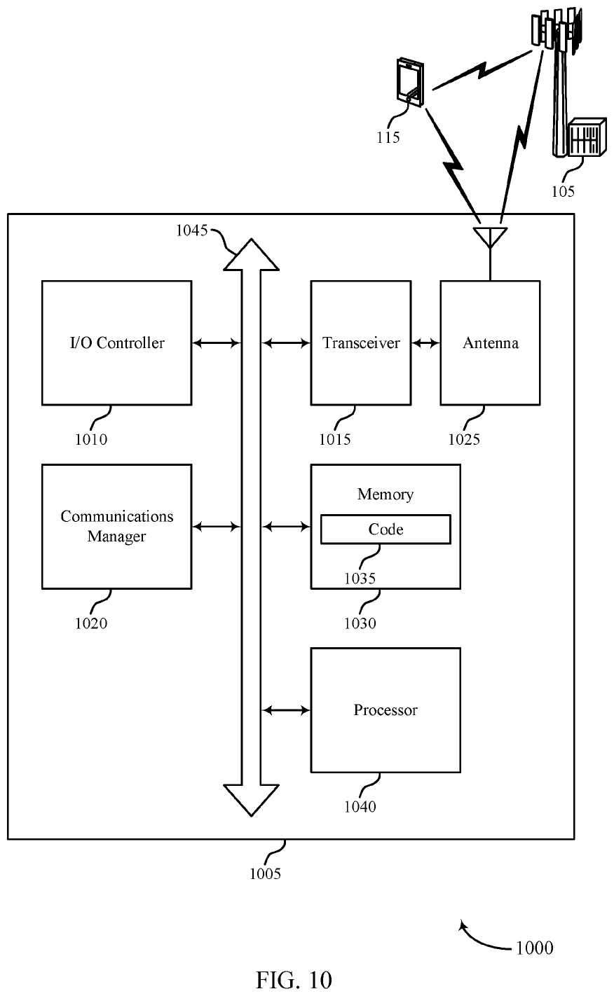

FIG. 10 shows a diagram of a system 1000 including a device 1005 that supports resource reservation techniques for sidelink communications in accordance with one or more aspects of the present disclosure. The device 1005 may be an example of or include the components of a device 705, a device 805, or a UE 115, as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links, as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting resource reservation techniques for sidelink communications). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at the device 1005 in accordance with examples disclosed herein. For example, the communications manager 1020 may be configured as or otherwise support a means for transmitting SCI that indicates a set of reserved resources for sidelink communications at the device 1005, each of the set of reserved resources including a respective slot of multiple slots and a respective sub-channel of a shared radio frequency channel that includes multiple sub-channels. The communications manager 1020 may be configured as or otherwise support a means for determining that a sub-channel of a reserved resource is occupied at a beginning of a slot of the reserved resource based on performing a first LBT procedure prior to the slot. The communications manager 1020 may be configured as or otherwise support a means for transmitting, via the sub-channel of the reserved resource, a sidelink message during a mini-slot of the reserved resource based on performing a second LBT procedure prior to the mini-slot, where the mini-slot begins after the beginning of the slot.

Additionally, or alternatively, the communications manager 1020 may support wireless communications at the device 1005 in accordance with other examples disclosed herein. For example, the communications manager 1020 may be configured as or otherwise support a means for transmitting SCI that indicates a set of reserved resources for sidelink communications at the device 1005, each of the set of reserved resources including a respective slot of multiple slots and a respective sub-channel of a shared radio frequency channel that includes multiple sub-channels. The communications manager 1020 may be configured as or otherwise support a means for performing a LBT procedure associated with a sub-channel of a reserved resource prior to a slot of the reserved resource. The communications manager 1020 may be configured as or otherwise support a means for transmitting a sidelink message with a CPE via the sub-channel of the reserved resource based on a result of the LBT procedure, where transmission of the CPE begins prior to the slot of the reserved resource.

Additionally, or alternatively, the communications manager 1020 may support wireless communications at the device 1005 in accordance with other examples disclosed herein. For example, the communications manager 1020 may be configured as or otherwise support a means for transmitting first SCI that indicates a set of reserved resources for sidelink communications at the device 1005, each of the set of reserved resources including a respective slot of multiple slots and a respective sub-channel of a shared radio frequency channel that includes multiple sub-channels. The communications manager 1020 may be configured as or otherwise support a means for determining that a sub-channel of a reserved resource is occupied during a first slot of the reserved resource based on performing a first LBT procedure prior to the first slot. The communications manager 1020 may be configured as or otherwise support a means for transmitting a sidelink message in a second slot based on performing a second LBT procedure prior to the second slot, where the second slot is based on the first slot.

Additionally, or alternatively, the communications manager 1020 may support wireless communications at the device 1005 (a first UE) in accordance with examples disclosed herein. For example, the communications manager 1020 may be configured as or otherwise support a means for receiving SCI that indicates a first set of reserved resources for sidelink communications at a second UE, each resource in the first set of reserved resources including a respective slot of multiple slots and a respective sub-channel of a shared radio frequency channel that includes multiple sub-channels. The communications manager 1020 may be configured as or otherwise support a means for transmitting an indication of the first set of reserved resources to a network entity based on a resource selection mode of the device 1005. The communications manager 1020 may be configured as or otherwise support a means for receiving control signaling that indicates a second set of reserved resources for sidelink communications by the device 1005, where the first set of reserved resources for the second UE is different from the second set of reserved resources for the device 1005.

By including or configuring the communications manager 1020 in accordance with examples, as described herein, the device 1005 may support techniques for fewer signal collisions, greater reliability, and higher throughput, among other benefits. For example, the device 1005 may transmit a CPE via a wireless medium prior to the start of a time slot in which the device 1005 intends to transmit a sidelink message, which may reduce the probability of other devices (e.g., Wi-Fi devices) using the wireless medium during the time slot. Moreover, if the device 1005 experiences an LBT failure prior to a last reserved slot, the device 1005 may transmit a CAT 2 LBT-based SCI (possibly multiplexed with an S-SSB) to reserve subsequent resources for sidelink communications in a shared radio frequency spectrum band.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of resource reservation techniques for sidelink communications, as described herein, or the processor 1040 and the memory 1030 may be otherwise configured to perform or support such operations.

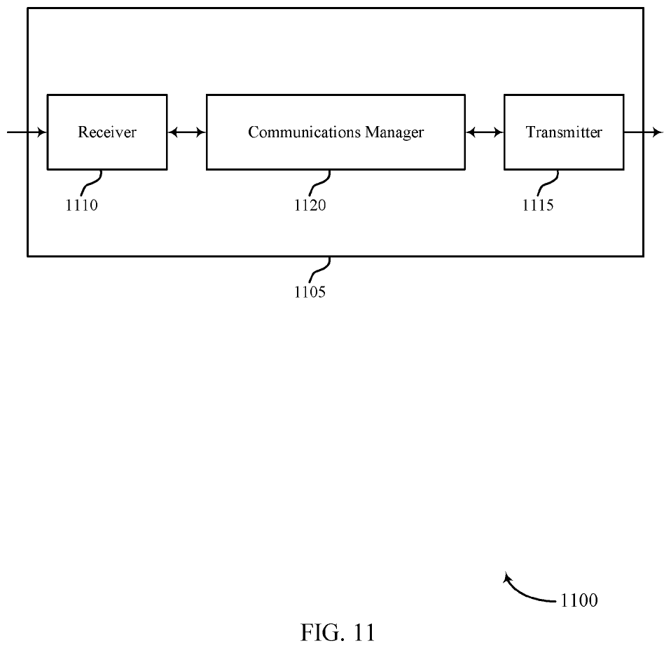

FIG. 11 shows a block diagram 1100 of a device 1105 that supports resource reservation techniques for sidelink communications in accordance with one or more aspects of the present disclosure. The device 1105 may be an example of aspects of a network entity 105, as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of resource reservation techniques for sidelink communications, as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations, as described herein.

The communications manager 1120 may support wireless communications at the device 1105 in accordance with examples disclosed herein. For example, the communications manager 1120 may be configured as or otherwise support a means for receiving an indication of a first set of reserved resources for sidelink communications by a first UE, each resource in the first set of reserved resources including a respective slot of multiple slots and a respective sub-channel of a shared radio frequency channel that includes multiple sub-channels. The communications manager 1120 may be configured as or otherwise support a means for transmitting control signaling to a second UE that indicates a second set of reserved resources for sidelink communications by the second UE, where the first set of reserved resources for the second UE is different from the second set of reserved resources for the UE.

By including or configuring the communications manager 1120 in accordance with examples, as described herein, the device 1105 (e.g., a processor controlling or otherwise coupled with the receiver 1110, the transmitter 1115, the communications manager 1120, or a combination thereof) may support techniques for more efficient utilization of communication resources by configuring a UE to reserve resources (for sidelink communications in a shared or unlicensed radio frequency spectrum band) with greater efficiency.

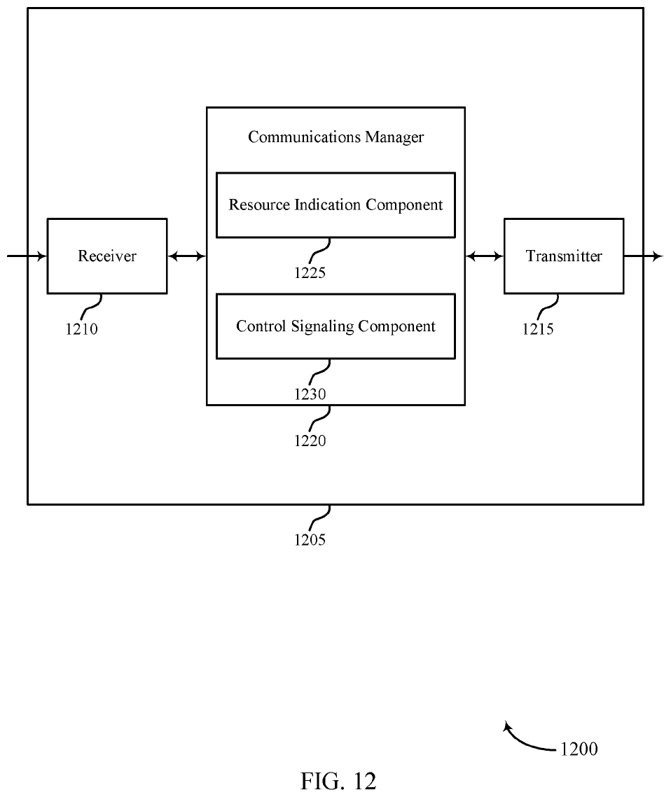

FIG. 12 shows a block diagram 1200 of a device 1205 that supports resource reservation techniques for sidelink communications in accordance with one or more aspects of the present disclosure. The device 1205 may be an example of aspects of a device 1105 or a network entity 105, as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of resource reservation techniques for sidelink communications, as described herein. For example, the communications manager 1220 may include a resource indication component 1225 a control signaling component 1230, or any combination thereof. The communications manager 1220 may be an example of aspects of a communications manager 1120, as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations, as described herein.

The communications manager 1220 may support wireless communications at the device 1205 in accordance with examples disclosed herein. The resource indication component 1225 may be configured as or otherwise support a means for receiving an indication of a first set of reserved resources for sidelink communications by a first UE, each resource in the first set of reserved resources including a respective slot of multiple slots and a respective sub-channel of a shared radio frequency channel that includes multiple sub-channels. The control signaling component 1230 may be configured as or otherwise support a means for transmitting control signaling to a second UE that indicates a second set of reserved resources for sidelink communications by the second UE, where the first set of reserved resources for the second UE is different from the second set of reserved resources for the UE.

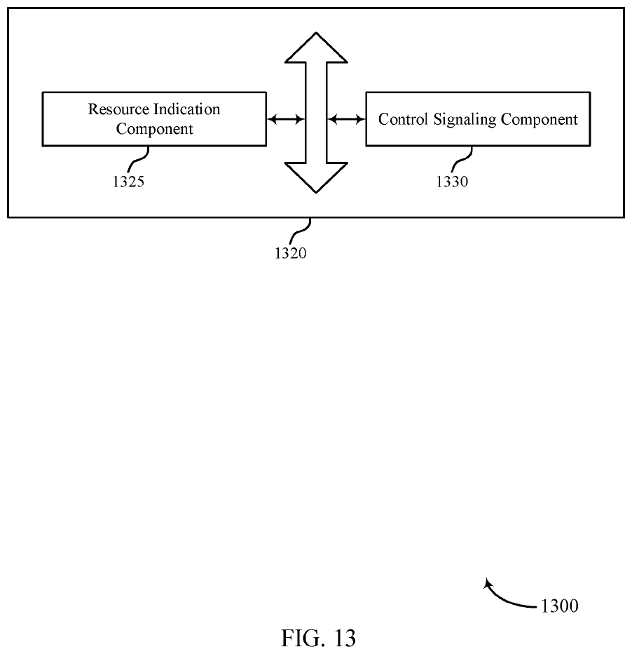

FIG. 13 shows a block diagram 1300 of a communications manager 1320 that supports resource reservation techniques for sidelink communications in accordance with one or more aspects of the present disclosure. The communications manager 1320 may be an example of aspects of a communications manager 1120 or a communications manager 1220, as described herein. The communications manager 1320, or various components thereof, may be an example of means for performing various aspects of resource reservation techniques for sidelink communications, as described herein. For example, the communications manager 1320 may include a resource indication component 1325 a control signaling component 1330, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples disclosed herein. The resource indication component 1325 may be configured as or otherwise support a means for receiving an indication of a first set of reserved resources for sidelink communications by a first UE, each resource in the first set of reserved resources including a respective slot of multiple slots and a respective sub-channel of a shared radio frequency channel that includes multiple sub-channels. The control signaling component 1330 may be configured as or otherwise support a means for transmitting control signaling to a second UE that indicates a second set of reserved resources for sidelink communications by the second UE, where the first set of reserved resources for the second UE is different from the second set of reserved resources for the UE.

In some examples, the second set of reserved resources does not overlap with a time gap reserved for a LBT procedure prior to each of the first set of reserved resources. In some examples, the time gap is based on a maximum contention window size associated with a priority level of the first UE, a minimum contention window size associated with the priority level of the first UE, a mean contention window size associated with the priority level of the first UE, or a combination thereof.

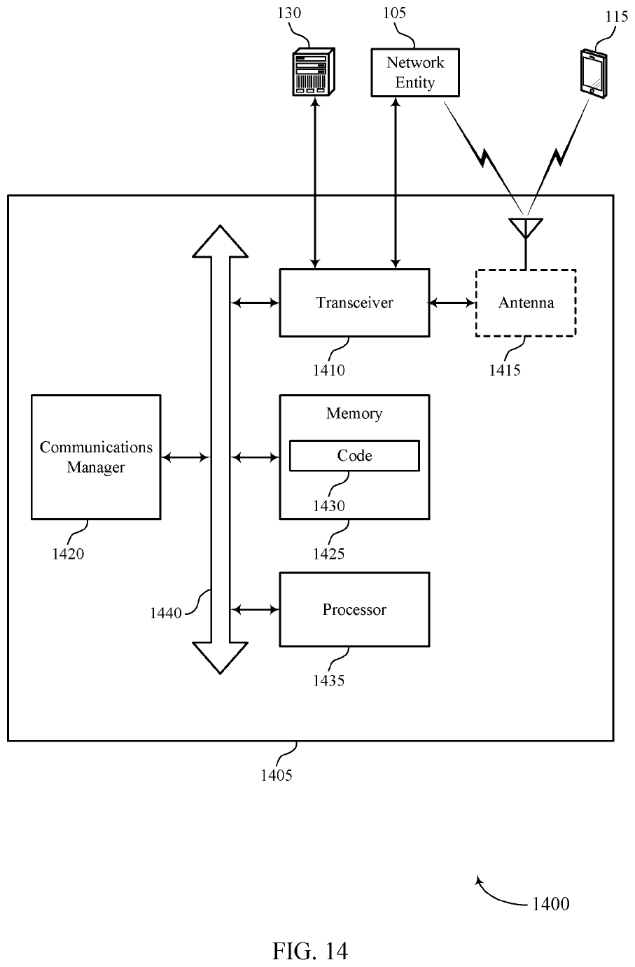

FIG. 14 shows a diagram of a system 1400 including a device 1405 that supports resource reservation techniques for sidelink communications in accordance with one or more aspects of the present disclosure. The device 1405 may be an example of or include the components of a device 1105, a device 1205, or a network entity 105, as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both, as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting resource reservation techniques for sidelink communications). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at the device 1405 in accordance with examples disclosed herein. For example, the communications manager 1420 may be configured as or otherwise support a means for receiving an indication of a first set of reserved resources for sidelink communications by a first UE, each resource in the first set of reserved resources including a respective slot of multiple slots and a respective sub-channel of a shared radio frequency channel that includes multiple sub-channels. The communications manager 1420 may be configured as or otherwise support a means for transmitting control signaling to a second UE that indicates a second set of reserved resources for sidelink communications by the second UE, where the first set of reserved resources for the second UE is different from the second set of reserved resources for the UE.

By including or configuring the communications manager 1420 in accordance with examples, as described herein, the device 1405 may support techniques for improved communication reliability, reduced latency, and higher throughput. More specifically, the device 1405 may configure a UE to transmit a CPE via a wireless medium prior to the start of a time slot in which the UE intends to transmit a sidelink message, which may reduce the probability of other devices (e.g., Wi-Fi devices) using the wireless medium during the time slot. Moreover, the device 1405 may configure a sidelink resource pool with a mini-slot structure such that the UE can perform a mini-slot transmission if the wireless medium is occupied at a slot boundary.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of resource reservation techniques for sidelink communications, as described herein, or the processor 1435 and the memory 1425 may be otherwise configured to perform or support such operations.

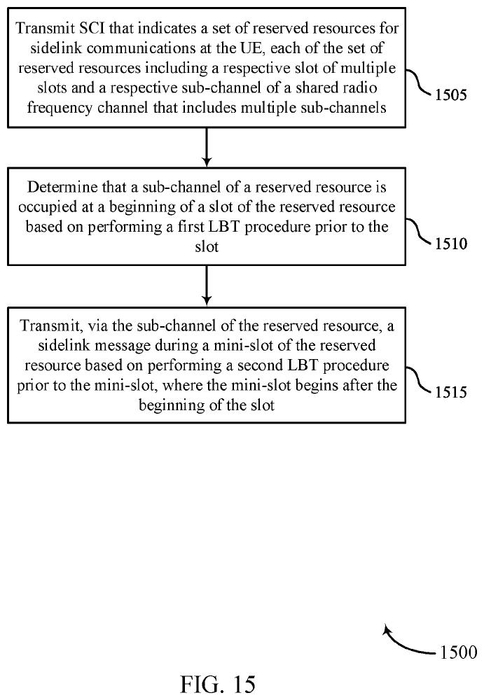

FIG. 15 shows a flowchart illustrating a method 1500 that supports resource reservation techniques for sidelink communications in accordance with one or more aspects of the present disclosure. The operations of the method 1500 may be implemented by a UE or components thereof. For example, the operations of the method 1500 may be performed by a UE 115, as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting SCI that indicates a set of reserved resources for sidelink communications at the UE, each of the set of reserved resources including a respective slot of multiple slots and a respective sub-channel of a shared radio frequency channel that includes multiple sub-channels. The operations of 1505 may be performed in accordance with examples disclosed herein. In some examples, aspects of the operations of 1505 may be performed by an SCI component 925, as described with reference to FIG. 9.

At 1510, the method may include determining that a sub-channel of a reserved resource is occupied at a beginning of a slot of the reserved resource based on performing a first LBT procedure prior to the slot. The operations of 1510 may be performed in accordance with examples disclosed herein. In some examples, aspects of the operations of 1510 may be performed by an LBT component 930, as described with reference to FIG. 9.

At 1515, the method may include transmitting, via the sub-channel of the reserved resource, a sidelink message during a mini-slot of the reserved resource based on performing a second LBT procedure prior to the mini-slot, where the mini-slot begins after the beginning of the slot. The operations of 1515 may be performed in accordance with examples disclosed herein. In some examples, aspects of the operations of 1515 may be performed by a sidelink message component 935, as described with reference to FIG. 9.

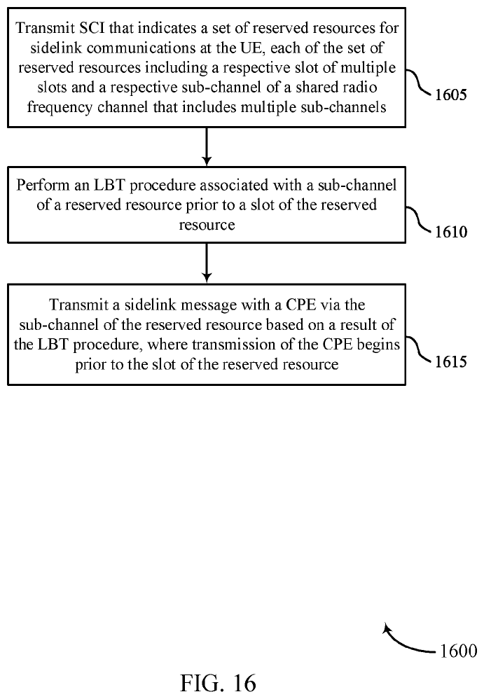

FIG. 16 shows a flowchart illustrating a method 1600 that supports resource reservation techniques for sidelink communications in accordance with one or more aspects of the present disclosure. The operations of the method 1600 may be implemented by a UE or components thereof. For example, the operations of the method 1600 may be performed by a UE 115, as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting SCI that indicates a set of reserved resources for sidelink communications at the UE, each of the set of reserved resources including a respective slot of multiple slots and a respective sub-channel of a shared radio frequency channel that includes multiple sub-channels. The operations of 1605 may be performed in accordance with examples disclosed herein. In some examples, aspects of the operations of 1605 may be performed by an SCI component 925, as described with reference to FIG. 9.

At 1610, the method may include performing a LBT procedure associated with a sub-channel of a reserved resource prior to a slot of the reserved resource. The operations of 1610 may be performed in accordance with examples disclosed herein. In some examples, aspects of the operations of 1610 may be performed by an LBT component 930, as described with reference to FIG. 9.

At 1615, the method may include transmitting a sidelink message with a CPE via the sub-channel of the reserved resource based on a result of the LBT procedure, where transmission of the CPE begins prior to the slot of the reserved resource. The operations of 1615 may be performed in accordance with examples disclosed herein. In some examples, aspects of the operations of 1615 may be performed by a sidelink message component 935, as described with reference to FIG. 9.

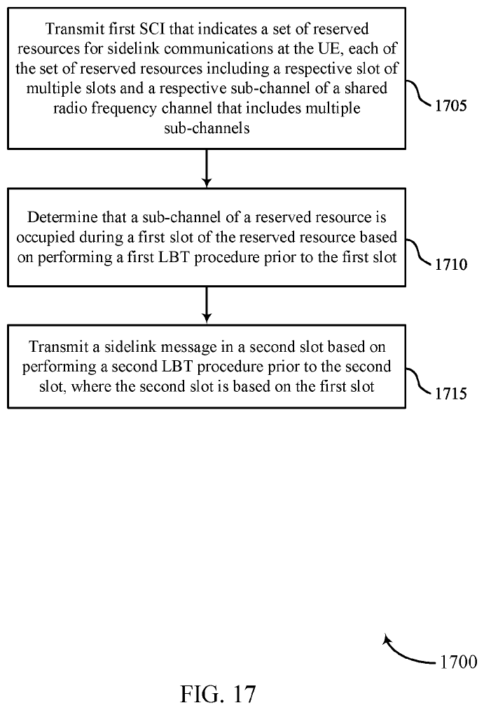

FIG. 17 shows a flowchart illustrating a method 1700 that supports resource reservation techniques for sidelink communications in accordance with one or more aspects of the present disclosure. The operations of the method 1700 may be implemented by a UE or components thereof. For example, the operations of the method 1700 may be performed by a UE 115, as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting first SCI that indicates a set of reserved resources for sidelink communications at the UE, each of the set of reserved resources including a respective slot of multiple slots and a respective sub-channel of a shared radio frequency channel that includes multiple sub-channels. The operations of 1705 may be performed in accordance with examples disclosed herein. In some examples, aspects of the operations of 1705 may be performed by an SCI component 925, as described with reference to FIG. 9.

At 1710, the method may include determining that a sub-channel of a reserved resource is occupied during a first slot of the reserved resource based on performing a first LBT procedure prior to the first slot. The operations of 1710 may be performed in accordance with examples disclosed herein. In some examples, aspects of the operations of 1710 may be performed by an LBT component 930, as described with reference to FIG. 9.

At 1715, the method may include transmitting a sidelink message in a second slot based on performing a second LBT procedure prior to the second slot, where the second slot is based on the first slot. The operations of 1715 may be performed in accordance with examples disclosed herein. In some examples, aspects of the operations of 1715 may be performed by a sidelink message component 935, as described with reference to FIG. 9.

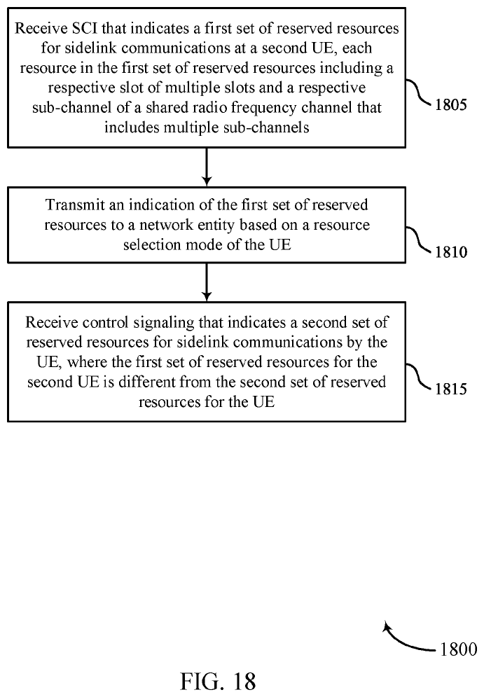

FIG. 18 shows a flowchart illustrating a method 1800 that supports resource reservation techniques for sidelink communications in accordance with one or more aspects of the present disclosure. The operations of the method 1800 may be implemented by a UE or components thereof. For example, the operations of the method 1800 may be performed by a UE 115, as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving SCI that indicates a first set of reserved resources for sidelink communications at a second UE, each resource in the first set of reserved resources including a respective slot of multiple slots and a respective sub-channel of a shared radio frequency channel that includes multiple sub-channels. The operations of 1805 may be performed in accordance with examples disclosed herein. In some examples, aspects of the operations of 1805 may be performed by an SCI component 925, as described with reference to FIG. 9.

At 1810, the method may include transmitting an indication of the first set of reserved resources to a network entity based on a resource selection mode of the UE. The operations of 1810 may be performed in accordance with examples disclosed herein. In some examples, aspects of the operations of 1810 may be performed by a resource indicating component 940, as described with reference to FIG. 9.

At 1815, the method may include receiving control signaling that indicates a second set of reserved resources for sidelink communications by the UE, where the first set of reserved resources for the second UE is different from the second set of reserved resources for the UE. The operations of 1815 may be performed in accordance with examples disclosed herein. In some examples, aspects of the operations of 1815 may be performed by a control signal component 945, as described with reference to FIG. 9.

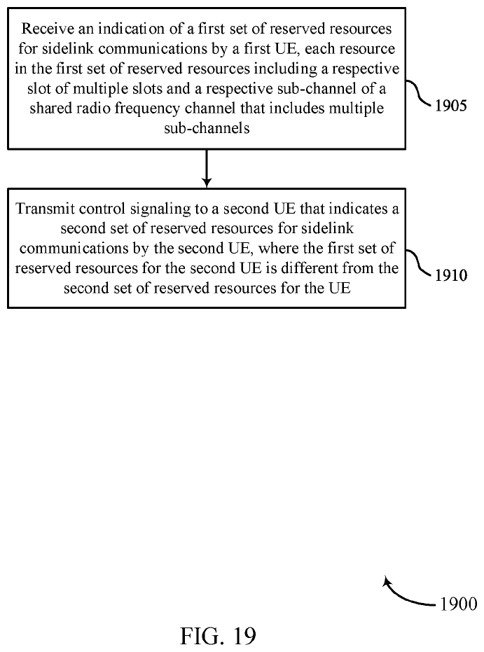

FIG. 19 shows a flowchart illustrating a method 1900 that supports resource reservation techniques for sidelink communications in accordance with one or more aspects of the present disclosure. The operations of the method 1900 may be implemented by a network entity or components thereof. For example, the operations of the method 1900 may be performed by a network entity 105, as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include receiving an indication of a first set of reserved resources for sidelink communications by a first UE, each resource in the first set of reserved resources including a respective slot of multiple slots and a respective sub-channel of a shared radio frequency channel that includes multiple sub-channels. The operations of 1905 may be performed in accordance with examples disclosed herein. In some examples, aspects of the operations of 1905 may be performed by a resource indication component 1325, as described with reference to FIG. 13.

At 1910, the method may include transmitting control signaling to a second UE that indicates a second set of reserved resources for sidelink communications by the second UE, where the first set of reserved resources for the second UE is different from the second set of reserved resources for the UE. The operations of 1910 may be performed in accordance with examples disclosed herein. In some examples, aspects of the operations of 1910 may be performed by a control signaling component 1330, as described with reference to FIG. 13.

The following provides an overview of aspects of the present disclosure:

Aspect 1: A method for wireless communications at a UE, comprising: transmitting sidelink control information that indicates a set of reserved resources for sidelink communications at the UE, each of the set of reserved resources comprising a respective slot of a plurality of slots and a respective sub-channel of a shared radio frequency channel that comprises a plurality of sub-channels; determining that a sub-channel of a reserved resource is occupied at a beginning of a slot of the reserved resource based at least in part on performing a first listen-before-talk procedure prior to the slot; and transmitting, via the sub-channel of the reserved resource, a sidelink message during a mini-slot of the reserved resource based at least in part on performing a second listen-before-talk procedure prior to the mini-slot, wherein the mini-slot begins after the beginning of the slot.

Aspect 2: The method of aspect 1, wherein the reserved resource is a first reserved resource that is prior to a second reserved resource of the set of reserved resources.

Aspect 3: The method of aspect 1, wherein transmitting the sidelink message during the mini-slot of the reserved resource is based at least in part on the reserved resource being a last reserved resource of the set of reserved resources.

Aspect 4: The method of any of aspects 1 through 3, wherein the sidelink control information indicates one or more of the set of reserved resources that are available for mini-slot transmissions.

Aspect 5: The method of any of aspects 1 through 4, further comprising: receiving an indication of a sidelink resource pool with a mini-slot structure; and selecting the set of reserved resources from the sidelink resource pool based at least in part on a resource selection mode of the UE.

Aspect 6: The method of any of aspects 1 through 5, wherein the set of reserved resources comprises a second reserved resource that occurs prior to the reserved resource, the method further comprising: performing a third listen-before-talk procedure prior to a second slot associated with the second reserved resource, wherein the third listen-before-talk procedure completes an offset prior to the second slot.

Aspect 7: The method of any of aspects 1 through 6, wherein the sidelink control information indicates respective channel access modifications for each of the set of reserved resources, and the respective channel access modifications for the reserved resource comprise a mini-slot channel access.

Aspect 8: A method for wireless communications at a UE, comprising: transmitting sidelink control information that indicates a set of reserved resources for sidelink communications at the UE, each of the set of reserved resources comprising a respective slot of a plurality of slots and a respective sub-channel of a shared radio frequency channel that comprises a plurality of sub-channels; performing a listen-before-talk procedure associated with a sub-channel of a reserved resource prior to a slot of the reserved resource; and transmitting a sidelink message with a cyclic prefix extension via the sub-channel of the reserved resource based at least in part on a result of the listen-before-talk procedure, wherein transmission of the cyclic prefix extension begins prior to the slot of the reserved resource.

Aspect 9: The method of aspect 8, wherein the reserved resource is a first reserved resource that is prior to a second reserved resource of the set of reserved resources.

Aspect 10: The method of aspect 8, wherein transmitting the sidelink message with the cyclic prefix extension is based at least in part on the reserved resource being a last reserved resource of the set of reserved resources.

Aspect 11: The method of any of aspects 8 through 10, wherein the sidelink control information indicates one or more of the set of reserved resources that are available for sidelink transmissions with cyclic prefix extensions.

Aspect 12: The method of any of aspects 8 through 11, wherein the sidelink control information indicates an offset for a candidate slot from the slot for retransmission of the sidelink message.

Aspect 13: The method of any of aspects 8 through 12, further comprising: receiving radio resource control signaling that indicates one or more possible durations of the cyclic prefix extension.

Aspect 14: The method of any of aspects 8 through 13, wherein a duration of the cyclic prefix extension is based at least in part on a priority level of the sidelink message.

Aspect 15: The method of any of aspects 8 through 14, wherein the UE is associated with a first radio access technology, and wherein transmitting the sidelink message with the cyclic prefix extension comprises: determining that use of the sub-channel by devices associated with a second radio access technology fails to satisfy a threshold.

Aspect 16: A method for wireless communications at a UE, comprising: transmitting first sidelink control information that indicates a set of reserved resources for sidelink communications at the UE, each of the set of reserved resources comprising a respective slot of a plurality of slots and a respective sub-channel of a shared radio frequency channel that comprises a plurality of sub-channels; determining that a sub-channel of a reserved resource is occupied during a first slot of the reserved resource based at least in part on performing a first listen-before-talk procedure prior to the first slot; and transmitting a sidelink message in a second slot based at least in part on performing a second listen-before-talk procedure prior to the second slot, wherein the second slot is based at least in part on the first slot.

Aspect 17: The method of aspect 16, wherein each of the set of reserved resources comprises a respective plurality of consecutive slots and a respective sub-channel of a shared radio frequency channel that comprises a plurality of sub-channels, and the respective plurality of consecutive slots for the reserved resource comprises the first slot and the second slot.

Aspect 18: The method of aspect 17, further comprising: suppressing performing additional listen-before-talk procedures to access the sub-channel for remaining slots of the respective plurality of consecutive slots of the reserved resource subsequent to the second slot.

Aspect 19: The method of any of aspects 17 through 18, further comprising: receiving radio resource control signaling that indicates a quantity of the respective plurality of consecutive slots the UE can reserve for each of the set of reserved resources; and selecting the set of reserved resources for transmission of the sidelink message based at least in part on the radio resource control signaling.

Aspect 20: The method of any of aspects 17 through 19, wherein the first sidelink control information indicates a quantity of the respective plurality of consecutive slots in each of the set of reserved resources.

Aspect 21: The method of any of aspects 17 through 20, further comprising: receiving second sidelink control information that indicates a second set of reserved resources for sidelink communications by a second UE, each of the second set of reserved resources comprising a respective plurality of consecutive slots and a respective sub-channel of the shared radio frequency channel; receiving third sidelink control information from the second UE in a first slot of the respective plurality of consecutive slots of a second reserved resource of the second set of reserved resources; and performing a listen-before-talk procedure for access to a corresponding sub-channel of the second reserved resource prior to a second slot of the respective plurality of consecutive slots of the second reserved resource based at least in part on receiving the third sidelink control information.

Aspect 22: The method of any of aspects 17 through 21, wherein transmitting the sidelink message comprises: transmitting the sidelink message with a cyclic prefix extension via the sub-channel of the reserved resource based at least in part on a result of the second listen-before-talk procedure, wherein transmission of the cyclic prefix extension begins prior to the second slot of the reserved resource.

Aspect 23: The method of aspect 22, wherein the sidelink message comprises a retransmission of a first message; and the first sidelink control information and the first message are transmitted in a third slot that precedes the first slot.

Aspect 24: The method of any of aspects 16 through 23, wherein the sidelink message comprises second sidelink control information, the method further comprising: multiplexing the second sidelink control information with a sidelink synchronization signal block in the second slot.

Aspect 25: The method of aspect 24, wherein the second sidelink control information indicates a second set of reserved resources for sidelink communications by the UE; and the first listen-before-talk procedure is a first type of listen-before-talk procedure and the second listen-before-talk procedure is a second type of listen-before-talk procedure.

Aspect 26: The method of any of aspects 24 through 25, wherein transmitting the second sidelink control information comprises: transmitting the sidelink synchronization signal block via resources of a sidelink resource pool.

Aspect 27: The method of any of aspects 24 through 26, wherein the second slot is allocated for transmission of the sidelink synchronization signal block, and wherein transmitting the second sidelink control information comprises: transmitting the second sidelink control information multiplexed with the sidelink synchronization signal block based at least in part on a time gap between a last slot of the set of reserved resources and the second slot.

Aspect 28: The method of aspect 27, wherein a duration of the time gap is configured via radio resource control signaling.

Aspect 29: The method of any of aspects 24 through 28, wherein the second sidelink control information is frequency division multiplexed with the sidelink synchronization signal block.

Aspect 30: A method for wireless communications at a UE, comprising: receiving sidelink control information that indicates a first set of reserved resources for sidelink communications at a second UE, each resource in the first set of reserved resources comprising a respective slot of a plurality of slots and a respective sub-channel of a shared radio frequency channel that comprises a plurality of sub-channels; transmitting an indication of the first set of reserved resources to a network entity based at least in part on a resource selection mode of the UE; and receiving control signaling that indicates a second set of reserved resources for sidelink communications by the UE, wherein the first set of reserved resources for the second UE is different from the second set of reserved resources for the UE.

Aspect 31: The method of aspect 30, further comprising: receiving a message that indicates a duration of a listen-before-talk procedure, a contention window size of the second UE, or both; and signaling one or both of the contention window size of the second UE or the duration of the listen-before-talk procedure to the network entity based at least in part on the resource selection mode of the UE.

Aspect 32: A method for wireless communications at a network entity, comprising: receiving an indication of a first set of reserved resources for sidelink communications by a first UE, each resource in the first set of reserved resources comprising a respective slot of a plurality of slots and a respective sub-channel of a shared radio frequency channel that comprises a plurality of sub-channels; and transmitting control signaling to a second UE that indicates a second set of reserved resources for sidelink communications by the second UE, wherein the first set of reserved resources for the second UE is different from the second set of reserved resources for the UE.

Aspect 33: The method of aspect 32, wherein the second set of reserved resources does not overlap with a time gap reserved for a listen-before-talk procedure prior to each of the first set of reserved resources.

Aspect 34: The method of aspect 33, wherein the time gap is based at least in part on a maximum contention window size associated with a priority level of the first UE, a minimum contention window size associated with the priority level of the first UE, a mean contention window size associated with the priority level of the first UE, or a combination thereof.

Aspect 35: An apparatus for wireless communications at a UE, comprising: a processor; memory coupled with the processor; and instructions stored in the memory and executable by the processor to cause the apparatus to perform a method of any of aspects 1 through 7.

Aspect 36: An apparatus for wireless communications at a UE, comprising at least one means for performing a method of any of aspects 1 through 7.

Aspect 37: A non-transitory computer-readable medium storing code for wireless communications at a UE, the code comprising instructions executable by a processor to perform a method of any of aspects 1 through 7.

Aspect 38: An apparatus for wireless communications at a UE, comprising: a processor; memory coupled with the processor; and instructions stored in the memory and executable by the processor to cause the apparatus to perform a method of any of aspects 8 through 15.

Aspect 39: An apparatus for wireless communications at a UE, comprising at least one means for performing a method of any of aspects 8 through 15.

Aspect 40: A non-transitory computer-readable medium storing code for wireless communications at a UE, the code comprising instructions executable by a processor to perform a method of any of aspects 8 through 15.

Aspect 41: An apparatus for wireless communications at a UE, comprising: a processor; memory coupled with the processor; and instructions stored in the memory and executable by the processor to cause the apparatus to perform a method of any of aspects 16 through 29.

Aspect 42: An apparatus for wireless communications at a UE, comprising at least one means for performing a method of any of aspects 16 through 29.

Aspect 43: A non-transitory computer-readable medium storing code for wireless communications at a UE, the code comprising instructions executable by a processor to perform a method of any of aspects 16 through 29.

Aspect 44: An apparatus for wireless communications at a UE, comprising: a processor; memory coupled with the processor; and instructions stored in the memory and executable by the processor to cause the apparatus to perform a method of any of aspects 30 through 31.

Aspect 45: An apparatus for wireless communications at a UE, comprising at least one means for performing a method of any of aspects 30 through 31.

Aspect 46: A non-transitory computer-readable medium storing code for wireless communications at a UE, the code comprising instructions executable by a processor to perform a method of any of aspects 30 through 31.

Aspect 47: An apparatus for wireless communications at a network entity, comprising: a processor; memory coupled with the processor; and instructions stored in the memory and executable by the processor to cause the apparatus to perform a method of any of aspects 32 through 34.

Aspect 48: An apparatus for wireless communications at a network entity, comprising at least one means for performing a method of any of aspects 32 through 34.

Aspect 49: A non-transitory computer-readable medium storing code for wireless communications at a network entity, the code comprising instructions executable by a processor to perform a method of any of aspects 32 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
transmitting sidelink control information that indicates a set of reserved resources for sidelink communications at the UE, each of the set of reserved resources comprising a respective slot of a plurality of slots and a respective sub-channel of a shared radio frequency channel that comprises a plurality of sub-channels;
determining that a sub-channel of a reserved resource is occupied at a beginning of a slot of the reserved resource based at least in part on performing a first listen-before-talk procedure prior to the slot; and
transmitting, via the sub-channel of the reserved resource, a sidelink message during a mini-slot of the reserved resource based at least in part on performing a second listen-before-talk procedure prior to the mini-slot, wherein the mini-slot begins after the beginning of the slot.

2. The method of claim 1, wherein the reserved resource is a first reserved resource that is prior to a second reserved resource of the set of reserved resources.

3. The method of claim 1, wherein transmitting the sidelink message during the mini-slot of the reserved resource is based at least in part on the reserved resource being a last reserved resource of the set of reserved resources.

4. The method of claim 1, wherein the sidelink control information indicates one or more of the set of reserved resources that are available for mini-slot transmissions.

5. The method of claim 1, further comprising:
receiving an indication of a sidelink resource pool with a mini-slot structure; and
selecting the set of reserved resources from the sidelink resource pool based at least in part on a resource selection mode of the UE.

6. The method of claim 1, wherein the set of reserved resources comprises a second reserved resource that occurs prior to the reserved resource, the method further comprising:
performing a third listen-before-talk procedure prior to a second slot associated with the second reserved resource, wherein the third listen-before-talk procedure completes an offset prior to the second slot.

7. The method of claim 1, wherein:
the sidelink control information indicates respective channel access modifications for each of the set of reserved resources, and
the respective channel access modifications for the reserved resource comprise a mini-slot channel access.

8. A method for wireless communications at a user equipment (UE), comprising:
transmitting sidelink control information that indicates a set of reserved resources for sidelink communications at the UE, each of the set of reserved resources comprising a respective slot of a plurality of slots and a respective sub-channel of a shared radio frequency channel that comprises a plurality of sub-channels;
performing a listen-before-talk procedure associated with a sub-channel of a reserved resource prior to a slot of the reserved resource; and
transmitting a sidelink message with a cyclic prefix extension via the sub-channel of the reserved resource based at least in part on a result of the listen-before-talk procedure, wherein transmission of the cyclic prefix extension begins prior to the slot of the reserved resource.

9. The method of claim 8, wherein the reserved resource is a first reserved resource that is prior to a second reserved resource of the set of reserved resources.

10. The method of claim 8, wherein transmitting the sidelink message with the cyclic prefix extension is based at least in part on the reserved resource being a last reserved resource of the set of reserved resources.

11. The method of claim 8, wherein the sidelink control information indicates one or more of the set of reserved resources that are available for sidelink transmissions with cyclic prefix extensions.

12. The method of claim 8, wherein the sidelink control information indicates an offset for a candidate slot from the slot for retransmission of the sidelink message.

13. The method of claim 8, further comprising:
receiving radio resource control signaling that indicates one or more possible durations of the cyclic prefix extension.

14. The method of claim 8, wherein a duration of the cyclic prefix extension is based at least in part on a priority level of the sidelink message.

15. The method of claim 8, wherein the UE is associated with a first radio access technology, and wherein transmitting the sidelink message with the cyclic prefix extension comprises:
determining that use of the sub-channel by devices associated with a second radio access technology fails to satisfy a threshold.

16. A method for wireless communications at a user equipment (UE), comprising:
transmitting first sidelink control information that indicates a set of reserved resources for sidelink communications at the UE, each of the set of reserved resources comprising a respective slot of a plurality of slots and a respective sub-channel of a shared radio frequency channel that comprises a plurality of sub-channels;
determining that a sub-channel of a reserved resource is occupied during a first slot of the reserved resource based at least in part on performing a first listen-before-talk procedure prior to the first slot; and
transmitting a sidelink message in a second slot based at least in part on performing a second listen-before-talk procedure prior to the second slot, wherein the second slot is based at least in part on the first slot.

17. The method of claim 16, wherein:
each of the set of reserved resources comprises a respective plurality of consecutive slots and a respective sub-channel of a shared radio frequency channel that comprises a plurality of sub-channels, and
the respective plurality of consecutive slots for the reserved resource comprises the first slot and the second slot.

18. The method of claim 17, further comprising:
suppressing performing additional listen-before-talk procedures to access the sub-channel for remaining slots of the respective plurality of consecutive slots of the reserved resource subsequent to the second slot.

19. The method of claim 17, further comprising:
receiving radio resource control signaling that indicates a quantity of the respective plurality of consecutive slots the UE can reserve for each of the set of reserved resources; and
selecting the set of reserved resources for transmission of the sidelink message based at least in part on the radio resource control signaling.

20. The method of claim 17, wherein the first sidelink control information indicates a quantity of the respective plurality of consecutive slots in each of the set of reserved resources.

21. The method of claim 17, further comprising:
receiving second sidelink control information that indicates a second set of reserved resources for sidelink communications by a second UE, each of the second set of reserved resources comprising a respective plurality of consecutive slots and a respective sub-channel of the shared radio frequency channel;
receiving third sidelink control information from the second UE in a first slot of the respective plurality of consecutive slots of a second reserved resource of the second set of reserved resources; and
performing a second listen-before-talk procedure for access to a corresponding sub-channel of the second reserved resource prior to a second slot of the respective plurality of consecutive slots of the second reserved resource based at least in part on receiving the third sidelink control information.

22. The method of claim 17, wherein transmitting the sidelink message comprises:
transmitting the sidelink message with a cyclic prefix extension via the sub-channel of the reserved resource based at least in part on a result of the second listen-before-talk procedure, wherein transmission of the cyclic prefix extension begins prior to the second slot of the reserved resource.

23. The method of claim 22, wherein:
the sidelink message comprises a retransmission of a first message; and
the first sidelink control information and the first message are transmitted in a third slot that precedes the first slot.

24. The method of claim 16, wherein the sidelink message comprises second sidelink control information, the method further comprising:
multiplexing the second sidelink control information with a sidelink synchronization signal block in the second slot.

25. The method of claim 24, wherein:
the second sidelink control information indicates a second set of reserved resources for sidelink communications by the UE; and
the first listen-before-talk procedure is a first type of listen-before-talk procedure and the second listen-before-talk procedure is a second type of listen-before-talk procedure.

26. The method of claim 24, wherein transmitting the second sidelink control information comprises:
transmitting the sidelink synchronization signal block via resources of a sidelink resource pool.

27. The method of claim 24, wherein the second slot is allocated for transmission of the sidelink synchronization signal block, and wherein transmitting the second sidelink control information comprises:
transmitting the second sidelink control information multiplexed with the sidelink synchronization signal block based at least in part on a time gap between a last slot of the set of reserved resources and the second slot.

28. The method of claim 27, wherein a duration of the time gap is configured via radio resource control signaling.

29. The method of claim 24, wherein the second sidelink control information is frequency division multiplexed with the sidelink synchronization signal block.

30. An apparatus for wireless communications at a user equipment (UE), comprising:
a processor;
memory coupled with the processor; and
instructions stored in the memory and executable by the processor to cause the apparatus to:
transmit sidelink control information that indicates a set of reserved resources for sidelink communications at the UE, each of the set of reserved resources comprising a respective slot of a plurality of slots and a respective sub-channel of a shared radio frequency channel that comprises a plurality of sub-channels;
determine that a sub-channel of a reserved resource is occupied at a beginning of a slot of the reserved resource based at least in part on performing a first listen-before-talk procedure prior to the slot; and
transmit, via the sub-channel of the reserved resource, a sidelink message during a mini-slot of the reserved resource based at least in part on performing a second listen-before-talk procedure prior to the mini-slot, wherein the mini-slot begins after the beginning of the slot.
